(19) United States
(12) Patent Application Publication
(10) Pub. No.: US 2018/0266290 A1
(43) Pub. Date: Sep. 20, 2018

(54) REAR ON-WALL DESIGN SCRF

(71) Applicant: Johnson Matthey Public Limited Company, London (GB)

(72) Inventors: Garry Adam BURGESS, Royston (GB); Guy Richard CHANDLER, Royston (GB); Keith Anthony FLANAGAN, Royston (GB); James GOOGAN, Royston (GB); David MARVELL, Royston (GB); Paul Richard PHILLIPS, Royston (GB)

(21) Appl. No.: 15/925,808

(22) Filed: Mar. 20, 2018

Related U.S. Application Data
(60) Provisional application No. 62/473,533, filed on Mar. 20, 2017.

(51) Int. Cl. F01N 3/035; F01N 3/20; F01N 3/28; B01J 29/76; B01J 35/04; B01D 53/94

(52) U.S. Cl. CPC F01N 3/035; B01D 2255/50; F01N 3/2828; B01J 29/763; B01J 35/04; B01D 53/9418; B01D 53/9472; F01N 2510/0684; F01N 2330/06; F01N 2370/04; F01N 2370/24; F01N 2510/063; B01D 2255/9155; B01D 2255/9032; B01D 2255/9035; B01D 2255/9037; F01N 3/2066

(57) ABSTRACT

A catalytic wall-flow monolith filter for use in an emission treatment system comprises a wall flow monolith comprising a porous substrate having surfaces that define the channels and having a first zone extending in the longitudinal direction from a first end face towards a second end face for a distance less than the filter length and a second zone downstream of the first zone, wherein a first SCR catalyst is distributed throughout the first zone of the porous substrate, and a second SCR catalyst is located on a layer that covers the surfaces in the second zone of the porous substrate. Systems and methods of using the filter in treating exhaust gases are described.

### FIELD OF THE INVENTION

The present invention relates to a catalytic wall-flow monolith comprising two zones, where the first zone comprises a first SCR catalyst distributed throughout the porous substrate, and the second zone comprises a second SCR catalyst located on a layer that covers the surfaces of the porous substrate in the second zone. The monolith is suitable for use in an emission treatment system, such as in mobile and stationary systems having internal combustion exhaust system. The monolith provides an effective method of remediating engine exhaust streams.

### BACKGROUND OF THE INVENTION

Hydrocarbon combustion in diesel engines, stationary gas turbines, and other systems generates exhaust gas that must be treated to remove nitrogen oxides (NOx), which comprises NO (nitric oxide) and NO₂ (nitrogen dioxide). NOx is known to cause a number of health issues in people as well as causing a number of detrimental environmental effects including the formation of smog and acid rain. To mitigate both the human and environmental impact from NOₓ in exhaust gas, it is desirable to eliminate these undesirable components, preferably by a process that does not generate other noxious or toxic substances.

Combustion of hydrocarbon-based fuel in engines and electrical power stations produces exhaust gas or flue that contains, in large part, relatively benign nitrogen (N₂), water vapor (H₂O), and carbon dioxide (CO₂). However, the exhaust and flue gases also contain, in relatively small part, noxious and/or toxic substances, such as carbon monoxide (CO) from incomplete combustion, hydrocarbons (HC) from un-burnt fuel, nitrogen oxides (NOₓ) from excessive combustion temperatures, and particulate matter (mostly soot). To mitigate the environmental impact of exhaust and flue gas released into the atmosphere, it is desirable to eliminate or reduce the amount of the undesirable components, preferably by a process that, in turn, does not generate other noxious or toxic substances.

Exhaust gas generated in lean-burn diesel engines is generally oxidative due to the high proportion of oxygen that is provided to ensure adequate combustion of the hydrocarbon fuel. NOx needs to be reduced selectively with a catalyst and a reductant in a process known as selective catalytic reduction (SCR) that converts NOx into elemental nitrogen (N₂) and water. This process can also form N₂O, a gas that is harmful to the ozone layer of the earth. In an SCR process, a gaseous reductant, typically anhydrous ammonia, aqueous ammonia, or urea, is added to an exhaust gas stream prior to the exhaust gas contacting the catalyst. The reductant is absorbed onto the catalyst and the NOₓ is reduced as the gases pass through and/or over the catalyzed substrate. In order to maximize the conversion of NOx, it is often necessary to add more than a stoichiometric amount of ammonia to the gas stream. However, release of the excess ammonia into the atmosphere would be detrimental to the health of people and to the environment. In addition, ammonia is caustic, especially in its aqueous form. Condensation of ammonia and water in regions of the exhaust line downstream of the exhaust catalysts can result in a corrosive mixture that can damage the exhaust system. Therefore, the release of ammonia in exhaust gas should be eliminated. In many conventional exhaust systems, an ammonia oxidation catalyst (also known as an ammonia slip catalyst or “ASC”) is installed downstream of the SCR catalyst to remove ammonia from the exhaust gas by converting it to nitrogen. The use of ammonia slip catalysts can allow for NOₓ conversions of greater than 90% over a typical diesel driving cycle.

In exhaust gases from diesel engines, one of the most burdensome components to remove is NOₓ. The reduction of NOₓ to N₂ is particularly problematic because the exhaust gas contains enough oxygen to favor oxidative reactions instead of reduction. Notwithstanding, NOₓ can be reduced by a process commonly known as Selective Catalytic Reduction (SCR). An SCR process involves the conversion of NOₓ, in the presence of a catalyst and with the aid of a nitrogenous reducing agent, such as ammonia, into elemental nitrogen (N₂) and water. In an SCR process, a gaseous reductant such as ammonia is added to an exhaust gas stream prior to contacting the exhaust gas with the SCR catalyst. The reductant is absorbed onto the catalyst and the NOₓ reduction reaction takes place as the gases pass through or over the catalyzed substrate. The chemical equation for stoichiometric SCR reactions using ammonia is:

4NO+4NH₃+O₂→4N₂+6H₂O

2NO₂+4NH₃+O₂→3N₂+6H₂O

NO+4NO₂+2NH₃→2N₂+3H₂O

Most SCR processes utilize a stoichiometric excess of ammonia in order to maximize the conversion of NOx. Unreacted ammonia that passes through the SCR process (also referred to as “ammonia slip”) is undesirable, because the released ammonia gas can negatively impact the atmosphere and can react with other combustion species. To reduce ammonia slip, SCR systems can include an ammonia oxidation catalyst (AMOX) (also known as an ammonia slip catalyst (ASC)) downstream of the SCR catalyst.

Accordingly, it is desirable to provide an improved catalysed wall-flow monolith that provides improved NOx conversion over a conventional SCRF in-wall design where the SCR catalyst is in the wall of the filter. It would also be desirable to have an improved catalysed wall-flow monolith that also provides improved NH₃ conversion. The present invention satisfies these needs.

### SUMMARY OF THE INVENTION

In a first aspect of the invention, a catalytic wall-flow monolith filter for use in an emission treatment system comprises a first end face, a second end face, a filter length defined by a distance from the first end face to the second end face, a longitudinal direction between the first end face and the second end face, and first and second pluralities of channels extending in the longitudinal direction,

wherein the first plurality of channels is open at the first end face and closed at the second end face, and the second plurality of channels is open at the second end face and closed at the first end face,

wherein the monolith filter comprises a porous substrate having surfaces that define the channels and having a first zone extending in the longitudinal direction from the first end face towards the second end face for a distance less than the filter length and a second zone downstream of the first zone,

wherein the first zone comprises a first SCR catalyst distributed throughout the porous substrate, and the second zone comprises a second SCR catalyst located on a layer that covers the surfaces of the porous substrate.

A second aspect of the invention relates to method for the manufacture of a catalytic wall-flow monolith filter, comprising:

(a) providing a porous substrate having a first end face and a second end face defining a longitudinal direction therebetween and first and second pluralities of channels extending in the longitudinal direction, wherein the first plurality of channels is open at the first end face and closed at the second end face, and wherein the second plurality of channels is open at the second end face and closed at the first end face;

(b) infiltrating the porous substrate with a washcoat comprising the first SCR catalyst to form a first zone and a portion of the second zone; or infiltrating the porous substrate with a washcoat comprising the first SCR catalyst to form a first zone and infiltrating the porous substrate with a washcoat comprising the first SCR catalyst to form a portion of the second zone; or infiltrating the porous substrate with a washcoat comprising the first SCR catalyst to form a portion of the second zone and infiltrating the porous substrate with a washcoat comprising the first SCR catalyst to form a first zone; and

(c) forming a coating of a second SCR catalyst in the second zone, where the walls of the second plurality of channels in the second zone are covered by the coating.

A third aspect of the invention relates to a system comprising a catalytic wall-flow monolith filter of the first aspect of the invention.

A fourth aspect of the invention relates to a method of treating an exhaust gas comprising contact an exhaust gas comprising NOx and ammonia with a catalytic wall-flow monolith filter of the first aspect of the invention.

### BRIEF DESCRIPTION OF THE DRAWINGS

The invention will now be described in relation to the following non-limiting figures.

FIG. 1 is a perspective view that schematically shows a wall flow monolith filter 1 having two zones according to one aspect of the present invention.

FIG. 2 is a schematic diagram showing the location of the two zones and the two SCR catalysts in an aspect of the invention.

FIG. 3 is a cross-sectional view of the wall flow monolith filter 1 shown through plane A-A in FIG. 1 where the filter has the zones shown in FIG. 2.

FIG. 4 is a schematic diagram showing the location of the two zones and the two SCR catalysts in an aspect of the invention.

FIG. 5 is a cross-sectional view of the wall flow monolith filter 1 shown through plane A-A in FIG. 1 where the filter has the zones shown in FIG. 4.

FIG. 6 is a schematic diagram showing the location of the two zones and the two SCR catalysts in an aspect of the invention.

FIG. 7 is a cross-sectional view of the wall flow monolith filter 1 shown through plane A-A in FIG. 1 where the filter has the zones shown in FIG. 6.

FIG. 8 is a perspective view that schematically shows a wall flow monolith filter 1 having three zones according to one aspect of the present invention.

FIG. 9 is a schematic diagram showing the location of the three zones and the two SCR catalysts in an aspect of the invention.

FIG. 10 is a cross-sectional view of the wall flow monolith filter 1 shown through plane A-A in FIG. 8 where the filter has the zones shown in FIG. 9.

FIG. 11 is a schematic diagram showing the location of the three zones and the two SCR catalysts in an aspect of the invention.

FIG. 12 is a cross-sectional view of the wall flow monolith filter 1 shown through plane A-A in FIG. 8 where the filter has the zones shown in FIG. 11.

FIG. 13 is a schematic diagram showing the location of the three zones and the two SCR catalysts in an aspect of the invention.

FIG. 14 is a cross-sectional view of the wall flow monolith filter 1 shown through plane A-A in FIG. 8 where the filter has the zones shown in FIG. 13.

FIG. 15 is a schematic diagram showing the location of the three zones and the two SCR catalysts in an aspect of the invention.

FIG. 16 is a cross-sectional view of the wall flow monolith filter 1 shown through plane A-A in FIG. 8 where the filter has the zones shown in FIG. 15.

FIG. 17 is a schematic diagram showing the location of the three zones and the two SCR catalysts in an aspect of the invention.

FIG. 18 is a cross-sectional view of the wall flow monolith filter 1 shown through plane A-A in FIG. 8 where the filter has the zones shown in FIG. 17.

FIG. 19 is a perspective view that schematically shows a wall flow monolith filter 1 having four zones according to one aspect of the present invention.

FIG. 20 is a schematic diagram showing the location of the four zones and the two SCR catalysts in an aspect of the invention.

FIG. 21 is a cross-sectional view of the wall flow monolith filter 1 shown through plane A-A in FIG. 19 where the filter has the zones shown in FIG. 20.

FIG. 22 is a schematic diagram showing the location of the four zones and the two SCR catalysts in an aspect of the invention.

FIG. 23 is a cross-sectional view of the wall flow monolith filter 1 shown through plane A-A in FIG. 19 where the filter has the zones shown in FIG. 22.

FIG. 24 is a schematic diagram of an exhaust gas treatment system for a diesel engine.

FIG. 25 is a schematic diagram of an exhaust gas treatment system for a diesel engine.

FIG. 26 is a schematic diagram showing the location of the two SCR catalysts in Example 1, a comparative example where the SCR catalyst is within the filter.

FIG. 27 is a cross-sectional view of the wall flow monolith filter showing the location of the two SCR catalysts in Example 1.

FIG. 28 is a schematic diagram showing the location of the two SCR catalysts in Example 3, a comparative example where an SCR catalyst is present as a coating on the filter in the front portion of the filter.

FIG. 29 is a cross-sectional view of the wall flow monolith filter showing the location of the two SCR catalysts in Example 3.

FIG. 30 is a graph showing the percent NOx conversion from a filter comprising a second SCR catalyst in a rear/on-wall configuration versus a conventional SCRF configuration over a temperature range of about 200 to about 625° C.

FIG. 31 is a graph showing the percent NOx conversion from a filter comprising a second SCR catalyst in a rear/on-wall configuration versus a conventional SCRF configuration over a temperature range of about 200 to about 625° C., where the filters had been hydrothermally aged at 900 C for 1 hour with 10% H₂O.

FIG. 32 is a graph showing the percent NH₃ conversion from a filter comprising a second SCR catalyst in a rear/on-wall configuration versus a conventional SCRF configuration over a temperature range of about 200 to about 625° C.

FIG. 33 is a graph showing the percent NH₃ conversion from a filter comprising a second SCR catalyst in a rear/on-wall configuration versus a conventional SCRF configuration over a temperature range of about 200 to about 625° C., where the filters had been hydrothermally aged at 900 C for 1 hour with 10% H₂O.

FIG. 34 is a graph showing the percent NOx conversion from a filter comprising a second SCR catalyst in a rear/on-wall configuration (Example 2) versus filter comprising a second SCR catalyst in a front/on-wall configuration (Example 3) over a temperature range of about 200 to about 625° C.

FIG. 35 shows the maximum temperatures determined by thermocouples in the regeneration of a filter with a front overlap of Example 3, where the first SCR catalyst was present as a coating on the substrate at a distance from about 75% from the rear of the filter and the second SCR was placed on about 30% of the length of the filter from the front of the filter.

FIG. 36 shows the maximum temperatures determined by thermocouples in the regeneration a filter with a rear overlap of Example 2, where an SCR catalyst was present as a coating on the substrate from the back of the filter to at a distance about 25% from the rear, and the rest of the filter had a SCR coating within the length of the filter.

### DETAILED DESCRIPTION OF THE INVENTION

The present invention will now be further described. In the following passages different aspects of the invention are defined in more detail. Each aspect so defined can be combined with any other aspect or aspects unless clearly indicated to the contrary. In particular, any feature indicated as being preferred or advantageous can be combined with any other feature or features indicated as being preferred or advantageous. The use of the terms “comprising” or “comprises” within the body of the application also encompasses the terms “consisting” or “consists of”.

The present invention relates to a catalytic wall-flow monolith filter comprising two SCR catalysts for use in an emission treatment system. FIGS. 1-23 show features of various configurations of wall flow monoliths encompassed by the invention. Below is an index with the name of the feature and the corresponding identifier in these figures.

| | |
|---|---|
| wall flow monolith | 1 |
| first subset of channels | 5 |
| second subset of channels | 10 |
| first end face | 15 |
| sealing material | 20 |
| second end face | 25 |
| channel wall | 30 |
| first zone | 35 |
| first SCR catalyst | 36 |
| second zone | 40 |
| second SCR catalyst | 42 |
| No catalyst | 45 |
| third zone | 50 |
| fourth zone | 55 |
| monolith length | a |
| length of first zone | b |
| length of second zone | c |
| length of third zone | d |
| length of fourth | e |
| exhaust gas | G |
| cross sectional plane | A-A |

The catalytic wall-flow monolith filter comprises two or more zones according to various aspects of the present invention. Catalytic wall-flow monoliths containing two zones are shown in FIGS. 1 to 7. Catalytic wall-flow monoliths containing three zones are shown in FIGS. 8 to 18. Catalytic wall-flow monoliths containing four zones are shown in FIGS. 19 to 23.

FIG. 1 shows a monolith filter with two zones. The monolith filter 1 has a first edge face 15 towards the front where exhaust gas enters the monolith filter 1 through a first subset of channels 5 that are open at the first end face 15 and sealed at the second end face 25. A second subset of channels 10 is sealed at the first end face 15 with sealing material 20 and have open ends at the second end face 25. The filter monolith comprises a first zone 35 having a length b and a second zone 40 having a length c. FIG. 1 also shows a plane A-A passing through the monolith filter.

A first zone 35 of the wall flow monolith 1 extends a distance b from the first end face 15 and is provided with a first SCR catalyst within pores of the channels walls 30. This can be provided using a washcoat application method, as is known in the art and is discussed elsewhere in the specification.

A second zone 40 of the wall flow monolith 1 is located downstream of the first zone 35. The second zone 40 extends a distance c from the second end face 25 towards the first end face 15 and can meet the first zone 35. The second zone 40 is provided with the first SCR catalyst 36 within pores of the channels walls 30. A surface coating comprising a second SCR catalyst 42, such as a zeolite (not necessarily, but preferably, the same as the first SCR catalyst 36, is positioned on the surface of the channel walls 30 within the second zone 40.

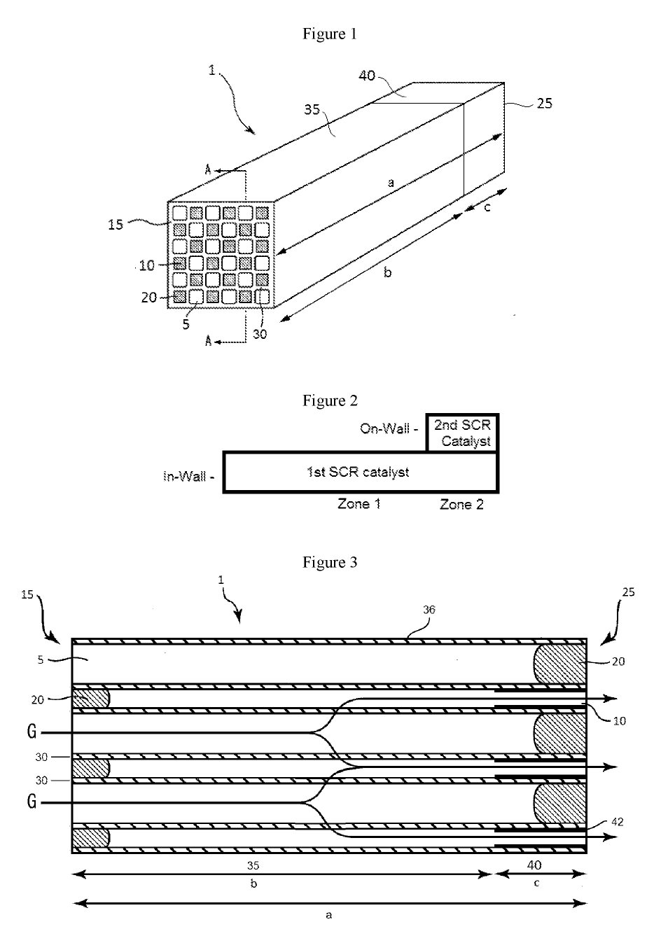

FIG. 2 is a schematic showing the location of the zones in the filter and the catalysts in the zones. There are two zones with the second zone 40 downstream of the first zone 35. Both of the zones comprises an SCR catalyst within the wall of the substrate. The second zone 40 also comprises a coating of a second SCR catalyst on the walls containing the first SCR catalyst.

FIG. 3 shows a cross-sectional view A-A of a filter monolith. The substrate comprises a first subset of channels 5 that are open at the first end face 15 of the wall flow monolith 1 and are sealed with a sealing material 20 at the second end face 25. A second subset of channels 10 is open at the second end face 25 of the wall flow monolith 1 and is sealed with a sealing material 20 at the first end face 15. The first end face 15 receives exhaust gas G from an engine. The exhaust gas G enters the monolith filter 1 at the open end of the first subset of channels 5. Gas passing down the first subset of channels 5 cannot exit the channel at the second end face 25 because the end is sealed 20. Exhaust gas G passes through the porous channel walls 30 and moves into the second subset of channels 10 and then exits the monolith filter at the second end face 25 which is connected to the exhaust system of the engine. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that contains the first SCR catalyst 36 within the walls 30 and a coating comprising a second SCR catalyst 42 on the walls 30 of the monolith filter. The second zone 40 is downstream of the first zone 35 and extends from the second end face 25 a distance c towards the second end face 25.

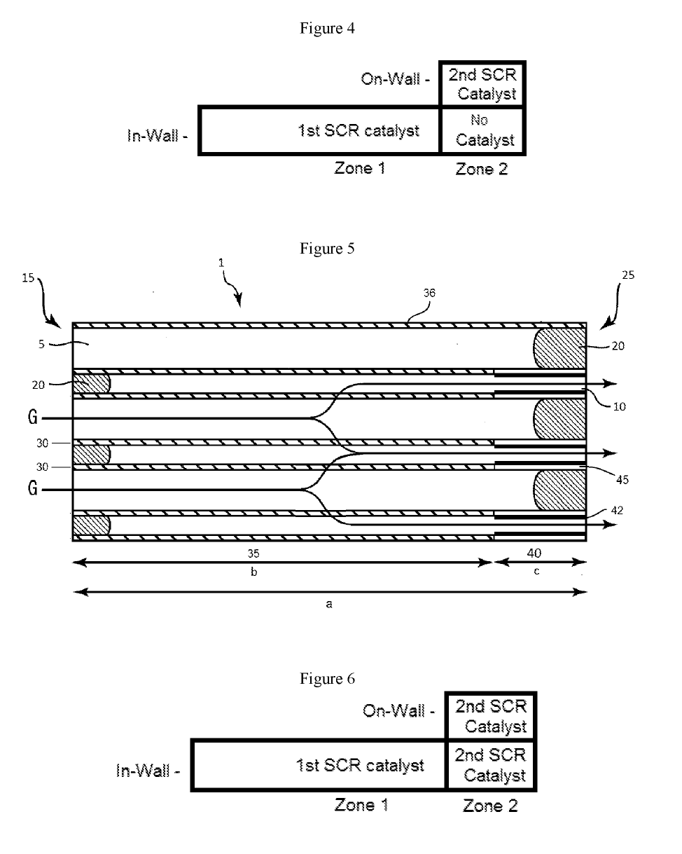

FIG. 4 is a schematic showing the location of the zones in the filter and the catalysts in the zones. There are two zones with the second zone 40 downstream of the first zone 35. Only the first zone 35 comprises an SCR catalyst within the wall of the substrate. The second zone 40 has a coating of a second SCR catalyst on the walls containing the first SCR catalyst but does not have a catalyst within the wall of the substrate.

FIG. 5 shows a cross-sectional view A-A of a filter monolith. The filter monolith substrate is as described above for FIG. 3 with a different description of the zones. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that contains a coating comprising a second SCR catalyst 42 on the walls 30 of the monolith filter. The second zone 40 does not contain an SCR catalyst within the walls 30 of the monolith filter. The second zone 40 is downstream of the first zone 35 and extends from the second end face 25 a distance c towards the second end face 25.

FIG. 6 is a schematic showing the location of the zones in the filter and the catalysts in the zones. There are two zones with the second zone 40 downstream of the first zone 35. Each of the zones have an SCR catalyst within the wall of the substrate. The first zone 35 comprises the first SCR catalyst within the wall of the substrate and the second zone 40 comprises the second SCR catalyst within the wall of the substrate. The second zone 40 also has a coating of a second SCR catalyst on the walls containing the second SCR catalyst.

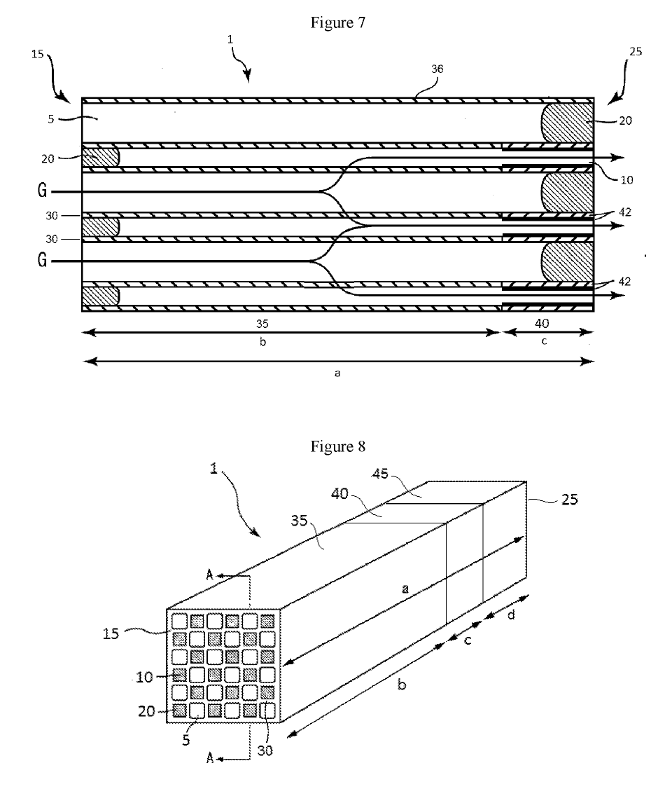

FIG. 7 shows a cross-sectional view A-A of a filter monolith. The filter monolith substrate is as described above for FIG. 3 with a different description of the zones. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that contains a second SCR catalyst 42 within the walls 30 of the monolith filter and as a coating on the walls 30 of the monolith filter. The second zone 40 is downstream of the first zone 35 and extends from the second end face 25 a distance c towards the second end face 25.

FIG. 8 shows a monolith filter with three zones. The monolith filter 1 has a first edge face 15 towards the front where exhaust gas enters the monolith filter 1 through a first subset of channels 5 that are open at the first end face 15 and sealed at the second end face 25. A second subset of channels 10 is sealed at the first end face 15 with sealing material 20 and have open ends at the second end face 25. The filter monolith comprises a first zone 35 having a length b, a second zone 40 having a length c and a third zone 50 having a length d. FIG. 8 also shows a plane A-A passing through the monolith filter.

A first zone 35 of the wall flow monolith 1 extends a distance b from the first end face 15 and is provided with a first SCR catalyst within pores of the channels walls 30. This can be provided using a washcoat application method, as is known in the art and is discussed elsewhere in the specification.

A second zone 40 of the wall flow monolith 1 is located downstream of the first zone 35. The second zone 40 extends a distance c from the first zone 35 towards the second end face 25. The second zone 40 can be provided with the first SCR catalyst 36, a second SCR catalyst 42, or a combination thereof within pores of the channels walls 30. Alternatively, the second zone 40 cannot have an SCR catalyst within pores of the channels walls 30. A surface coating comprising a second SCR catalyst 42, such as a zeolite (not necessarily, but preferably, the same as the first SCR catalyst 36), is positioned on the surface of the channel walls 30 within the second zone 40.

A third zone 50 of the wall flow monolith 1 is located downstream of the second zone 40. The third zone extends a distance d from the second zone 40 towards the second end face 25 and can meet the second zone 40. The third zone 50 is provided with the first SCR catalyst 36, the second SCR catalyst 42, or a combination thereof within pores of the channels walls 30. Alternatively, the second zone 40 cannot have an SCR catalyst within pores of the channels walls 30. The third zone 50 can contain a surface coating comprising a second SCR catalyst 42 on the surface of the channel walls 30.

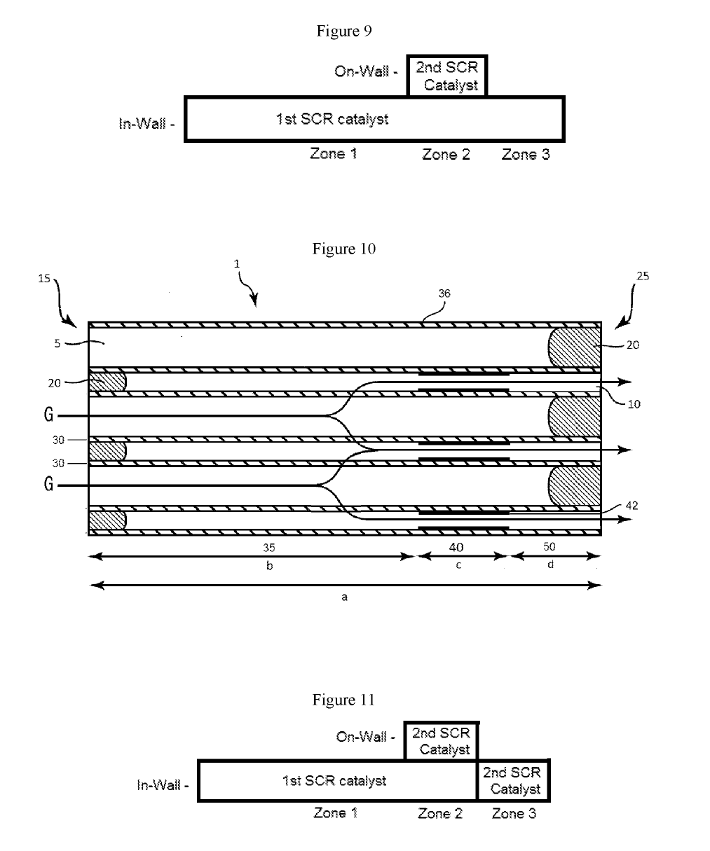

FIG. 9 is a schematic showing the location of the zones in the filter and the catalysts in the zones. There are three zones with the second zone 40 downstream of the first zone 35 and the third zone 50 downstream of the second zone 40. All three zones comprise a first SCR catalyst within the wall of the substrate. The second zone 40 also comprises a coating of a second SCR catalyst on the walls containing the first SCR catalyst.

FIG. 10 shows a cross-sectional view A-A of a filter monolith. The filter monolith substrate is as described above for FIG. 3 with a different description of the zones. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that contains the first SCR catalyst 36 within the walls 30 of the monolith filter and a coating containing the second SCR catalyst 42 on the walls 30 of the monolith filter. The second zone 40 is downstream of the first zone 35 and extends from the second end face 25 a distance c towards the second end face 25. The monolith filter also comprises a third zone 50 that contains the first SCR catalyst 36 within the walls 30 of the monolith filter. The third zone 50 is downstream of the second zone 40 and extends from the second zone 40 a distance d towards the second end face 25.

FIG. 11 is a schematic showing the location of the zones in the filter and the catalysts in the zones. There are three zones with the second zone 40 downstream of the first zone 35 and the third zone 50 downstream of the second zone 40. All three zones comprise an SCR catalyst within the wall of the substrate, with the first and second zones having the first SCR catalyst within the wall of the substrate and the third zone 50 having the second SCR catalyst within the wall of the substrate. The second zone 40 also comprises a coating of a second SCR catalyst on the walls containing the first SCR catalyst.

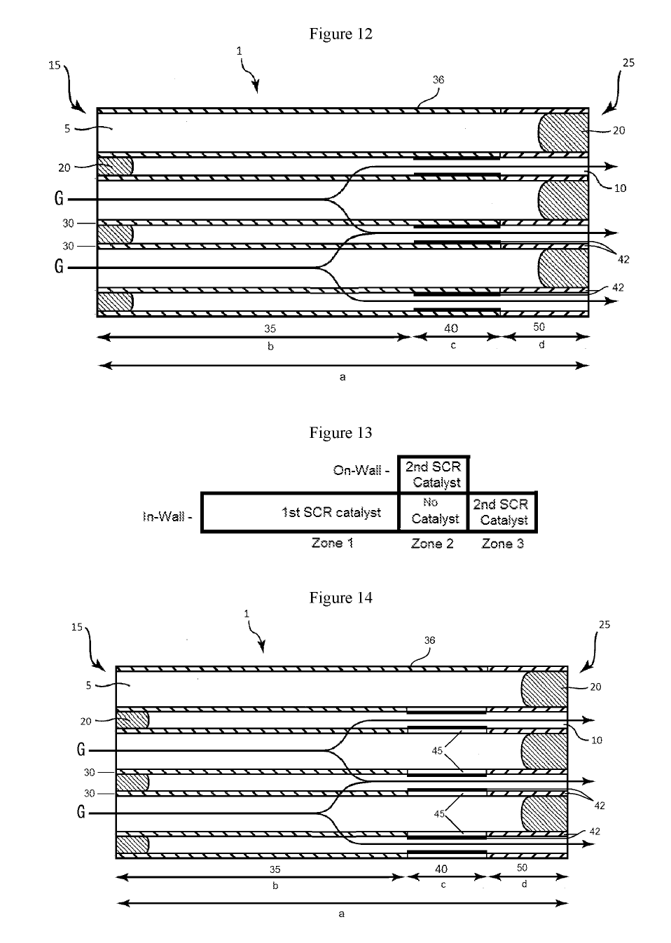

FIG. 12 shows a cross-sectional view A-A of a filter monolith. The monolith filter substrate comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that contains the first SCR catalyst 36 within the walls 30 of the monolith filter and a coating containing the second SCR catalyst 42 on the walls 30 of the monolith filter. The second zone 40 is downstream of the first zone 35 and extends from the second end face 25 a distance c towards the second end face 25. The monolith filter also comprises a third zone 50 that contains the second SCR catalyst 36 within the walls 30 of the monolith filter. The third zone 50 is downstream of the second zone 40 and extends from the second zone 40 a distance d towards the second end face 25.

FIG. 13 is a schematic showing the location of the zones in the filter and the catalysts in the zones. There are three zones with the second zone 40 downstream of the first zone 35 and the third zone 50 downstream of the second zone 40. The first and third zones comprise an SCR catalyst within the wall of the substrate, with the first zone 35 having the first SCR catalyst within the wall of the substrate and the third zone 50 having the second SCR catalyst within the wall of the substrate. The second zone 40 does not have an SCR catalyst within the wall of the substrate. The second zone 40 comprises a coating of a second SCR catalyst on the walls that do not contain an SCR catalyst.

FIG. 14 shows a cross-sectional view A-A of a filter monolith. The filter monolith substrate is as described above for FIG. 3 with a different description of the zones. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that does not contain an SCR catalyst within the walls 30 of the monolith filter but has a coating containing the second SCR catalyst 42 on the walls 30 of the monolith filter. The second zone 40 is downstream of the first zone 35 and extends from the second end face 25 a distance c towards the second end face 25. The monolith filter also comprises a third zone 50 that contains the second SCR catalyst 36 within the walls 30 of the monolith filter. The third zone 50 is downstream of the second zone 40 and extends from the second zone 40 a distance d towards the second end face 25.

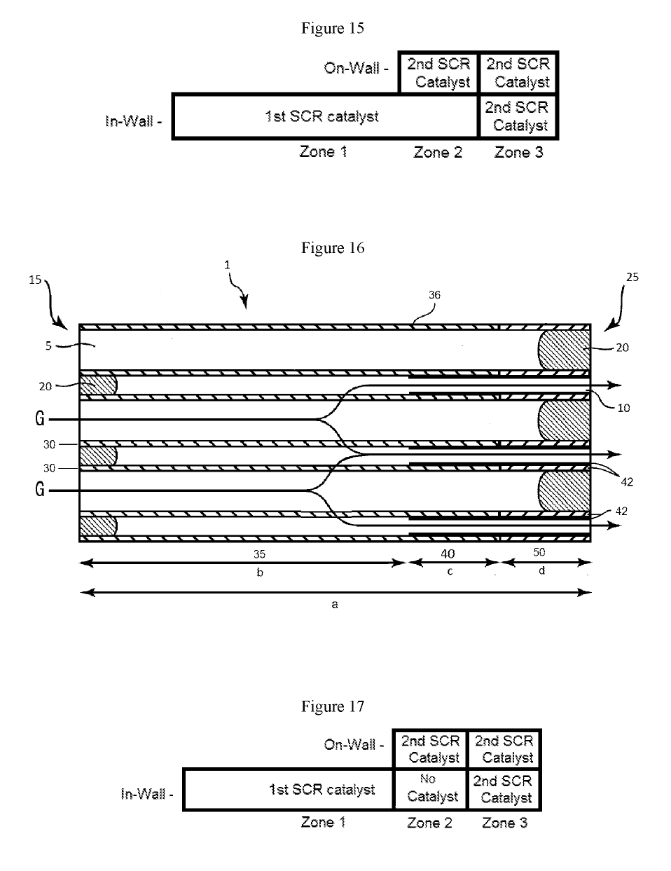

FIG. 15 is a schematic showing the location of the zones in the filter and the catalysts in the zones. There are three zones with the second zone 40 downstream of the first zone 35 and the third zone 50 downstream of the second zone 40. All three zones comprise an SCR catalyst within the wall of the substrate, with the first and second zones having the first SCR catalyst within the wall of the substrate and the third zone 50 having the second SCR catalyst within the wall of the substrate. The second and third zones comprises a coating of a second SCR catalyst on the walls that contain an SCR catalyst.

FIG. 16 shows a cross-sectional view A-A of a filter monolith. The filter monolith substrate is as described above for FIG. 3 with a different description of the zones. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that contains the first SCR catalyst 36 within the walls 30 of the monolith filter and a coating containing the second SCR catalyst 42 on the walls 30 of the monolith filter. The second zone 40 is downstream of the first zone 35 and extends from the second end face 25 a distance c towards the second end face 25. The monolith filter also comprises a third zone 50 that contains the second SCR catalyst 36 within the walls 30 of the monolith filter and a coating containing the second SCR catalyst 42 on the walls 30 of the monolith filter. The third zone 50 is downstream of the second zone 40 and extends from the second zone 40 a distance d towards the second end face 25.

FIG. 17 is a schematic showing the location of the zones in the filter and the catalysts in the zones. There are three zones with the second zone 40 downstream of the first zone 35 and the third zone 50 downstream of the second zone 40. The first and third zones comprise an SCR catalyst within the wall of the substrate, with the first zone 35 having the first SCR catalyst within the wall of the substrate and the third zone 50 having the second SCR catalyst within the wall of the substrate. The second and third zones comprises a coating of a second SCR catalyst on the walls that contain an SCR catalyst.

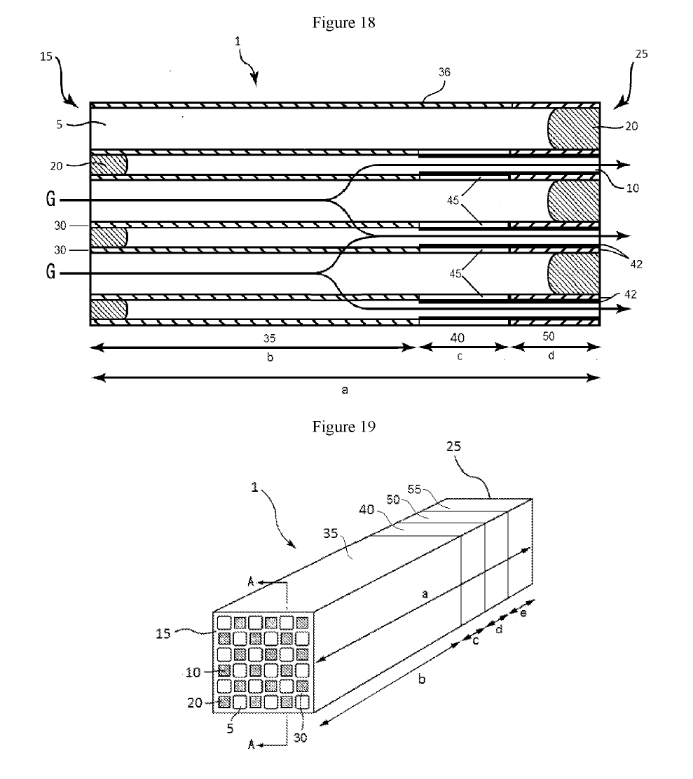

FIG. 18 shows a cross-sectional view A-A of a filter monolith. The filter monolith substrate is as described above for FIG. 3 with a different description of the zones. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that does not contain an SCR catalyst within the walls 30 of the monolith filter but has a coating containing the second SCR catalyst 42 on the walls 30 of the monolith filter. The second zone 40 is downstream of the first zone 35 and extends from the second end face 25 a distance c towards the second end face 25. The monolith filter also comprises a third zone 50 that contains the second SCR catalyst 36 within the walls 30 of the monolith filter and a coating containing the second SCR catalyst 42 on the walls 30 of the monolith filter. The third zone 50 is downstream of the second zone 40 and extends from the second zone 40 a distance c towards the second end face 25.

FIG. 19 shows a monolith filter with four zones. The monolith filter 1 has a first edge face 15 towards the front where exhaust gas enters the monolith filter 1 through a first subset of channels 5 that are open at the first end face 15 and sealed at the second end face 25. A second subset of channels 10 is sealed at the first end face 15 with sealing material 20 and have open ends at the second end face 25. The filter monolith comprises a first zone 35 having a length b, a second zone 40 having a length c and a third zone 50 having a length d.

FIG. 19 also shows a plane A-A passing through the monolith filter.

A first zone 35 of the wall flow monolith 1 extends a distance b from the first end face 15 and is provided with a first SCR catalyst within pores of the channels walls 30. This can be provided using a washcoat application method, as is known in the art and is discussed elsewhere in the specification.

A second zone 40 of the wall flow monolith 1 is located downstream of the first zone 35. The second zone 40 extends a distance c from the first zone 35 towards the second end face 25. The second zone 40 can be provided with the first SCR catalyst 36 within pores of the channels walls 30. Alternatively, the second zone 40 cannot have an SCR catalyst within pores of the channels walls 30. A surface coating comprising a second SCR catalyst 42, such as a zeolite (not necessarily, but preferably, the same as the first SCR catalyst 36), is positioned on the surface of the channel walls 30 within the second zone 40.

A third zone 50 of the wall flow monolith 1 is located downstream of the second zone 40. The third zone extends a distance d from the second zone 40 towards the second end face 25 and can meet the second zone 40. The third zone 50 is provided with the second SCR catalyst 42 within pores of the channels walls 30 and a surface coating comprising a second SCR catalyst 42 on the surface of the channel walls 30.

A fourth zone 55 of the wall flow monolith 1 is located downstream of the third zone 50. The fourth zone extends a distance e from the third zone 50 towards the second end face 25 and can meet the third zone 50. The fourth zone 50 is provided with the second SCR catalyst 42 within pores of the channels walls 30.

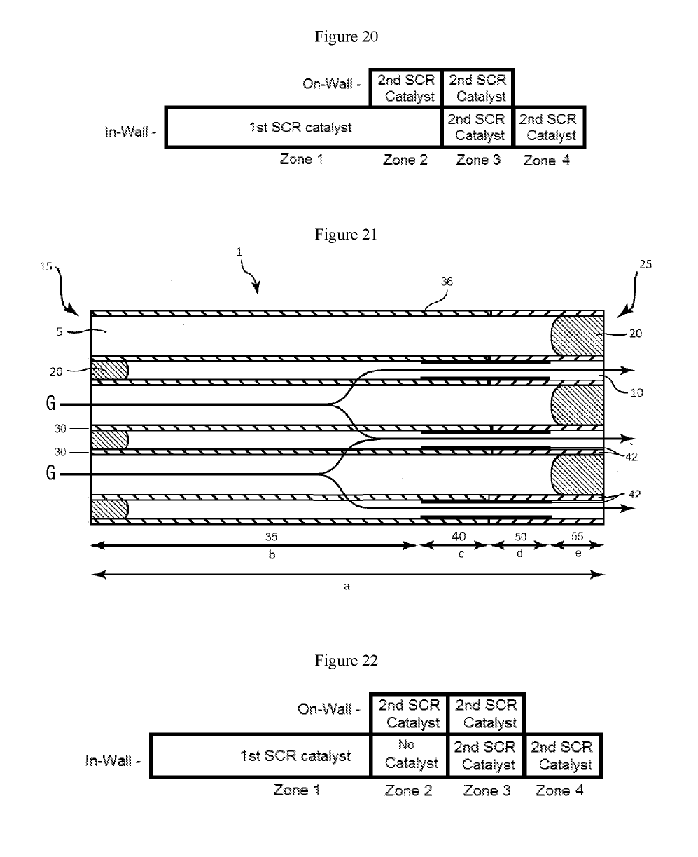

FIG. 20 is a schematic showing the location of the zones in the filter and the catalysts in the zones. There are four zones with the second zone 40 downstream of the first zone 35, the third zone 50 downstream of the second zone 40 and the fourth zone 55 downstream of the third zone 50. Each of the four zones comprise an SCR catalyst within the wall of the substrate, with the first zone 35 and the second zone 40 having the first SCR catalyst within the wall of the substrate and the third zone 50 and the fourth zone 55 having the second SCR catalyst 42 within the wall of the substrate. The second and third zones comprises a coating of a second SCR catalyst on the walls that contain an SCR catalyst.

FIG. 21 shows a cross-sectional view A-A of a filter monolith. The filter monolith substrate is as described above for FIG. 3 with a different description of the zones. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that contains the first SCR catalyst 36 within the walls 30 of the monolith filter and has a coating containing the second SCR catalyst 42 on the walls 30 of the monolith filter. The second zone 40 is downstream of the first zone 35 and extends from the first zone a distance c towards the second end face 25. The monolith filter comprises a third zone 50 that contains the second SCR catalyst 42 within the walls 30 of the monolith filter and a coating containing the second SCR catalyst 42 on the walls 30 of the monolith filter. The third zone 50 is downstream of the second zone 40 and extends from the second zone 40 a distance d towards the second end face 25. The monolith filter also comprises a fourth zone 55 that contains the second SCR catalyst 36 within the walls 30 of the monolith filter. The fourth zone 55 is downstream of the third zone 50 and extends from the third zone 50 a distance e towards the second end face 25.

FIG. 22 is a schematic showing the location of the zones in the filter and the catalysts in the zones. There are four zones with the second zone 40 downstream of the first zone 35, the third zone 50 downstream of the second zone 40 and the fourth zone 55 downstream of the third zone 50. The first, third and fourth zones comprise an SCR catalyst within the wall of the substrate, with the first zone 35 having the first SCR catalyst within the wall of the substrate and the third zone 50 and the fourth zone 55 having the second SCR catalyst 42 within the wall of the substrate. The third zone 50 does not have an SCR catalyst within the wall of the substrate. The second and third zones comprises a coating of a second SCR catalyst 42 on the walls.

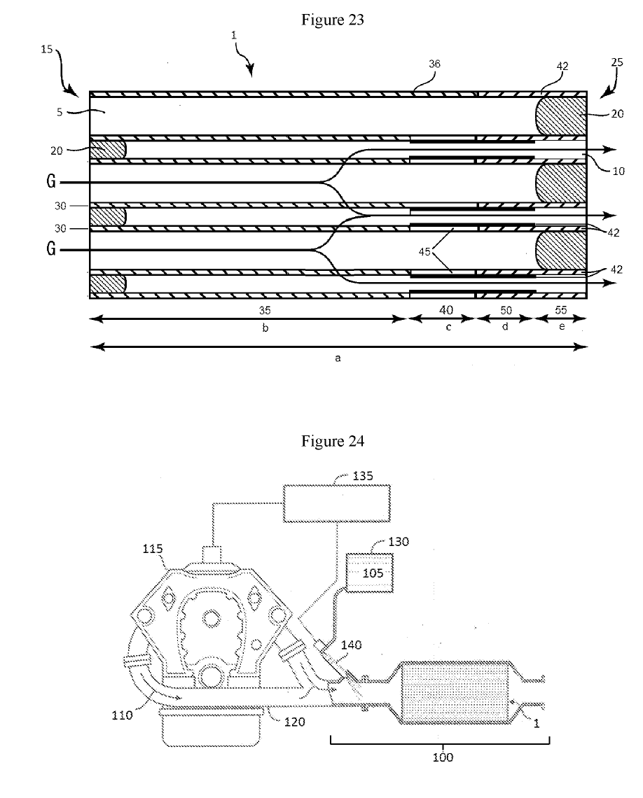

FIG. 23 shows a cross-sectional view A-A of a filter monolith. The filter monolith substrate is as described above for FIG. 3 with a different description of the zones. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that does not contain an SCR catalyst within the walls 30 of the monolith filter but has a coating containing the second SCR catalyst 42 on the walls 30 of the monolith filter. The second zone 40 is downstream of the first zone 35 and extends from the first zone a distance c towards the second end face 25. The monolith filter comprises a third zone 50 that contains the second SCR catalyst 42 within the walls 30 of the monolith filter and a coating containing the second SCR catalyst 42 on the walls 30 of the monolith filter. The third zone 50 is downstream of the second zone 40 and extends from the second zone 40 a distance d towards the second end face 25. The monolith filter also comprises a fourth zone 55 that contains the second SCR catalyst 36 within the walls 30 of the monolith filter. The fourth zone 55 is downstream of the third zone 50 and extends from the third zone 50 a distance e towards the second end face 25.

Two adjacent zones (the first and second zones, the second and third zones, the third and fourth zones) can preferably meet at a border that is preferably in a plane approximately parallel to the first and second end faces. This facilitates the wash-coating process. However, it is also possible to have a border which varies across the cross-section of the monolith, such as a cone-shaped border. This can advantageously be used to increase the volume of the second zone within the monolith, since a central area of the monolith can experience elevated temperatures.

The catalytic wall-flow monolith filter can further comprise a gap between at least a portion of one or more of two adjacent zones (the first and second zones, the second and third zones, the third and fourth zones).

Preferably there is no gap between at least a portion of one or more of adjacent zones (the first and second zones, the second and third zones, the third and fourth zones).

Wall Flow Monoliths

Wall-flow monoliths are well-known in the art for use in diesel particulate filters. They work by forcing a flow of exhaust gases (including particulate matter) to pass through walls formed of a porous material.

The wall-flow monolith has a first end face, which is the inlet for exhaust gases, a second end face, which is an outlet for the exhaust gas, defining a longitudinal direction therebetween.

A wall-flow monolithic filter comprises many parallel channels separated by thin walls that run axially through the monolith and are coated with one or more catalysts. The term “walls” means the physical structure of the substrate that forms the channels. The term “channel” means a space formed by walls in the substrate. The cross section of the channels can be round, oval or polygonal (triangular, square, rectangular, hexagonal or trapazoidal). The structure is reminiscent of a honeycomb.

A wall-flow monolith has first and second pluralities of channels extending in the longitudinal direction. The first plurality of channels is open at the first end face and closed at the second end face. The second plurality of channels is open at the second end face and closed at the first end face. The channels are preferably parallel to each other and provide a relatively constant wall thickness between the channels. As a result, gases entering one of the plurality of channels cannot leave the monolith without diffusing through the channel walls into the other plurality of channels. The channels are closed with the introduction of a sealant material into the open end of a channel. Preferably the number of channels in the first plurality is equal to the number of channels in the second plurality, and each plurality is evenly distributed throughout the monolith.

The wall-flow monolith comprises a number of cells. The term “cell” means a channel surrounded by one or more walls. The number of cells per unit cross-sectional area is the cell density”. Preferably the mean cross-sectional width of the first and second pluralities of channels, in combination with the porous walls, results in a cell density of 100 to 600, preferably 200 to 400, cells per square inch (cpsi) (15.5 to 93 cells per square cm (cpscm), preferably 31 to 64 cpscm). The channels can be of a constant width and each plurality of channels can have a uniform channel width. Preferably, however, the plurality of channels that serves as the inlet in use has a greater mean cross-sectional width than the plurality of channels that serves as the outlet. Preferably, the difference is at least 10%. This affords an increased ash storage capacity in the filter, meaning that a lower regeneration frequency can be used. Asymmetric filters are described in WO 2005/030365, which is incorporated herein by reference.

Preferably the mean minimum thickness of the substrate between adjacent channels (i.e., wall thickness) is from 6 to 20 mil, inclusive (where a “mil” is 1/1000 inch) (0.015 to 0.05 cm). Since the channels are preferably parallel and preferably have a constant width, the minimum wall thickness between adjacent channels is preferably constant. As will be appreciated, it is necessary to measure the mean minimum distance to ensure a reproducible measurement. For example, if the channels have a circular cross-section and are closely packed, then there is at least one point where the wall is thinnest between two adjacent channels. The wall thickness is preferably associated with the wall porosity and/or mean pore size. For example, the wall thickness can be between 10 and 50 times the mean pore size.

In order to facilitate the passage of gases to be treated through the channel walls, the monolith is formed out of a porous substrate. The substrate can also act as a support for holding catalytic material. Suitable materials for forming the porous substrate include ceramic-like materials such as cordierite, α-alumina, silicon carbide, silicon nitride, zirconia, mullite, spodumene, alumina-silica-magnesia or zirconium silicate, or porous, refractory metal. Wall-flow substrates can also be formed of ceramic fiber composite materials. Preferred wall-flow substrates are formed from cordierite and silicon carbide. Such materials are able to withstand the environment, particularly the high temperatures, encountered in treating the exhaust streams and can be made sufficiently porous. Such materials and their use in the manufacture of porous monolith substrates is well known in the art.

Preferably the monolith filter is porous and can have a porosity of 40 to 75%. Suitable techniques for determining porosity are known in the art and include mercury porosimetry and x-ray tomography. Preferably the coated porous substrate has a porosity of about 25 to 50% and the catalyst surface coating has a porosity of 25 to 75%. The porosity of the catalyst coating can be higher than the porosity of the coated porous substrate or the coated porous substrate can have a higher porosity relative to the porosity of the catalyst coating.

The wall flow monolith is preferably a single component. However, the monolith can be formed by adhering together a plurality of channels or by adhering together a plurality of smaller monoliths as described herein. Such techniques are well known in the art, as well as suitable casings and configurations of the emission treatment system.

SCR Catalysts

The SCR catalysts can be an oxide of a base metal, a molecular sieve, a metal exchanged molecular sieve or a mixture thereof. The base metal can be selected from the group consisting of cerium (Ce), chromium (Cr), cobalt (Co), copper (Cu), iron (Fe), manganese (Mn), molybdenum (Mo), nickel (Ni), tungsten (W), vanadium (V), and mixtures thereof. SCR compositions consisting of vanadium supported on a refractory metal oxide such as alumina, silica, zirconia, titania, ceria and combinations thereof are well known and widely used commercially in mobile applications. Typical compositions are described in U.S. Pat. Nos. 4,010,238 and 4,085,193, of which the entire contents are incorporated herein by reference. Compositions used commercially, especially in mobile applications, comprise TiO₂ on to which WO₃ and V₂O₅ have been dispersed at concentrations ranging from 5 to 20 wt. % and 0.5 to 6 wt. %, respectively. These catalysts may contain other inorganic materials such as SiO₂ and ZrO₂ acting as binders and promoters.

When the SCR catalyst is a base metal, the catalyst article can further comprise at least one base metal promoter. As used herein, a “promoter” is understood to mean a substance that when added into a catalyst, increases the activity of the catalyst. The base metal promoter can be in the form of a metal, an oxide of the metal, or a mixture thereof. The at least one base metal catalyst promoter may be selected from barium (Ba), calcium (Ca), cerium (Ce), lanthanum (La), magnesium (Mg), manganese (Mn), molybdenum (Mo), neodymium (Nd), niobium (Nb), praseodymium (Pr), strontium (Sr), tantalum (Ta), tantalum (Ta), tin (Sn), zinc (Zn), zirconium (Zr), and oxides thereof. The at least one base metal catalyst promoter can preferably be CeO₂, CoO, CuO, Fe₂O₃, MnO₂, Mn₂O₃, SnO₂, and mixtures thereof. The at least one base metal catalyst promoter may be added to the catalyst in the form of a salt in an aqueous solution, such as a nitrate or an acetate. The at least one base metal catalyst promoter and at least one base metal catalyst, e.g., copper, may be impregnated from an aqueous solution onto the oxide support material(s), may be added into a washcoat comprising the oxide support material(s), or may be impregnated into a support previously coated with the washcoat. The SCR catalyst can contain from at least about 0.1 weight percent, at least about 0.5 weight percent, at least about 1 weight percent, or at least about 2 weight percent to at most about 10 weight percent, about 7 weight percent, about 5 weight percent of a promoter metal based on the total weight of the promoter metal and support.

The SCR catalyst can comprise a molecular sieve or a metal exchanged molecular sieve. As is used herein “molecular sieve” is understood to mean a metastable material containing tiny pores of a precise and uniform size that may be used as an adsorbent for gases or liquids. The molecules which are small enough to pass through the pores are adsorbed while the larger molecules are not. The molecular sieve can be a zeolitic molecular sieve, a non-zeolitic molecular sieve, or a mixture thereof.

A zeolitic molecular sieve is a microporous aluminosilicate having any one of the framework structures listed in the Database of Zeolite Structures published by the International Zeolite Association (IZA). The framework structures include, but are not limited to those of the CHA, BEA, FAU, LTA, MFI, and MOR types. Non-limiting examples of zeolites having these structures include chabazite, faujasite, zeolite Y, ultrastable zeolite Y, beta zeolite, mordenite, silicalite, zeolite X, and ZSM-5. Aluminosilicate zeolites can have a silica/alumina molar ratio (SAR) defined as SiO₂/Al₂O₃) from at least about 5, preferably at least about 20, with useful ranges of from about 10 to 200.

As used herein, the term “non zeolitic molecular sieve” refers to corner sharing tetrahedral frameworks where at least a portion of the tetrahedral sites are occupied by an element other than silicon or aluminum. Specific non-limiting examples of non-zeolitic molecular sieves include silicoaluminophosphates such as SAPO-34, SAPO-37 and SAPO-44. The silicoaluminophosphates can have framework structures that contain framework elements that are found in zeolites, such as BEA, CHA, FAU, LTA, MFI, MOR and other types described below.

The SCR catalyst can comprise a small pore, a medium pore or a large pore molecular sieve, or combinations thereof.

The SCR catalyst can comprise a small pore molecular sieve selected from the group consisting of aluminosilicate molecular sieves, metal-substituted aluminosilicate molecular sieves, aluminophosphate (AlPO) molecular sieves, metal-substituted aluminophosphate (MeAlPO) molecular sieves, silico-aluminophosphate (SAPO) molecular sieves, and metal substituted silico-aluminophosphate (MeAPSO) molecular sieves, and mixtures thereof. The SCR catalyst can comprise a small pore molecular sieve selected from the group of Framework Types consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, LTA, MER, MON, NSI, OWE, PAU, PHI, RHO, RTH, SAT, SAV, SIV, THO, TSC, UEI, UFI, VNI, YUG, and ZON, and mixtures and/or intergrowths thereof. Preferably the small pore molecular sieve is selected from the group of Framework Types consisting of AEI, AFX, CHA, DDR, ERI, ITE, KFI, LTA, LEV, and SFW.

The SCR catalyst comprises can comprise a medium pore molecular sieve selected from the group of Framework Types consisting of AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, -PAR, PCR, PON, PUN, RRO, RSN, SFF, SFG, STF, STI, STT, STW, -SVR, SZR, TER, TON, TUN, UOS, VSV, WEI, and WEN, and mixtures and/or intergrowths thereof. Preferably, the medium pore molecular sieve selected from the group of Framework Types consisting of FER, MFI, and STT.

The SCR catalyst can comprise a large pore molecular sieve selected from the group of Framework Types consisting of AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, -RON, RWY, SAF, SAO, SBE, SBS, SBT, SEW, SFE, SFO, SFS, SFV, SOF, SOS, STO, SSF, SSY, USI, UWY, and VET, and mixtures and/or intergrowths thereof. Preferably, the large pore molecular sieve is selected from the group of Framework Types consisting of BEA, MOR and OFF.

A metal exchanged molecular sieve can have at least one metal from one of the groups VB, VIB, VIIB, VIIIB, IB, or IIB of the periodic table deposited onto extra-framework sites on the external surface or within the channels, cavities, or cages of the molecular sieves. Metals may be in one of several forms, including, but not limited to, zerovalent metal atoms or clusters, isolated cations, mononuclear or polynuclear oxycations, or as extended metal oxides. Preferably, the metals can be iron, copper, and mixtures or combinations thereof.

The metal can be combined with the zeolite using a mixture or a solution of the metal precursor in a suitable solvent. The term “metal precursor” means any compound or complex that can be dispersed on the zeolite to give a catalytically-active metal component. Preferably the solvent is water due to both economics and environmental aspects of using other solvents. When copper, a preferred metal is used, suitable complexes or compounds include, but are not limited to, anhydrous and hydrated copper sulfate, copper nitrate, copper acetate, copper acetylacetonate, copper oxide, copper hydroxide, and salts of copper ammines (e.g. [Cu(NH₃)₄]²⁺). This invention is not restricted to metal precursors of a particular type, composition, or purity. The molecular sieve can be added to the solution of the metal component to form a suspension, which is then allowed to react so that the metal component is distributed on the zeolite. The metal can be distributed in the pore channels as well as on the outer surface of the molecular sieve. The metal can be distributed in ionic form or as a metal oxide. For example, copper may be distributed as copper (II) ions, copper (I) ions, or as copper oxide. The molecular sieve containing the metal can be separated from the liquid phase of the suspension, washed, and dried. The resulting metal-containing molecular sieve can then be calcined to fix the metal in the molecular sieve.

A metal exchanged molecular sieve can contain in the range of about 0.10% and about 10% by weight of a group VB, VIB, VIIB, VIIIB, IB, or IIB metal located on extra framework sites on the external surface or within the channels, cavities, or cages of the molecular sieve. Preferably, the extra framework metal can be present in an amount of in the range of about 0.2% and about 5% by weight.

The metal exchanged molecular sieve can be a copper (Cu) supported small pore molecular sieve having from about 0.1 to about 20.0 wt. % copper of the total weight of the catalyst. Preferably copper is present from a about 1 wt. % to about 6 wt. % of the total weight of the catalyst, more preferably from about 1.8 wt. % to about 4.2 wt. % of the total weight of the catalyst.

The metal exchanged molecular sieve can be an iron (Fe) supported small pore molecular sieve having from about 0.1 to about 20.0 wt. % iron of the total weight of the catalyst. Preferably iron is present from about 1 wt. % to about 6 wt. % of the total weight of the catalyst, more preferably from about 1.8 wt. % to about 4.2 wt. % of the total weight of the catalyst.

The metal exchanged molecular sieve can be a manganese (Mn) supported small pore molecular sieve having from about 0.1 to about 20.0 wt. % manganese of the total weight of the catalyst. Preferably manganese is present from about 1 wt. % to about 6 wt. % of the total weight of the catalyst, more preferably from about 1.8 wt. % to about 4.2 wt. % of the total weight of the catalyst.

A catalyst is generally applied to a wall-flow monolith filter in combination with one or more non-catalytic materials, such as supports, binders, rheology modifiers, promoters, stabilizers, etc. This combination is often referred to as a washcoat.

In order to provide a catalytic wall-flow monolith of the present invention, catalytic material must be applied to the porous substrate, typically in the form of a washcoat. The application can be characterised as “in wall” application or “on wall” application. “In-wall” means that the catalytic material is present in the pores within the porous material. “On wall” means the catalyst material is present as a catalyst coating on the walls of the channels. The term “catalyst coating” means a catalytic material that is present on the walls of a monolith filter in a thickness of about 0.1 to 15% of the thickness of the wall upon which the coating is disposed. Some of the catalytic material in an on-wall application can be present in-wall.

The techniques for “in wall” or “on wall” application can depend on the viscosity of the material applied, the application technique (spraying or dipping, for example) and the presence of different solvents. Such application techniques are known in the art. The viscosity of the washcoat is influenced, for example, by its solids content. It is also influenced by the particle size distribution of the washcoat—a relatively flat distribution will give a different viscosity to a finely milled washcoat with a sharp peak in its particle size distribution—and rheology modifiers such as guar gums and other gums. Suitable coating methods are described in WO1999/047260, WO2011/080525 and WO2014/195685, which are incorporated herein by reference.

It is possible using conventional techniques to provide different zones within the substrate having different distributions of catalytic material. For example, where “on wall” application to a specific zone of the substrate is desired, a protective polymeric coating (such as polyvinyl acetate) can be applied to the remaining zone so that the catalyst coating does not form there. Once the residual washcoat has been removed, for example under vacuum, the protective polymeric coating can be burnt off.

The first zone comprises a first SCR catalyst distributed throughout the porous substrate, preferably substantially throughout the porous substrate. Examples of the first SCR catalyst are discussed above. This catalyst is included in the pores of the substrate, such as by infiltration with a washcoating method. This coats the pores and holds catalytic material therein, while maintaining sufficient porosity for the gases to penetrate through the channel walls. The first SCR catalyst is provided throughout the porous substrate within the first zone. A majority of the pores can contain the first SCR catalyst. “Distributed throughout the porous substrate” means that the material is found within the porous substrate, that is, between the walls of the substrate. This can be visually observed, for example using microscopy or various other techniques described below, depending upon the catalyst.

The second zone has the first SCR catalyst distributed throughout the porous substrate and a second SCR catalyst as a coating on the walls of the substrate over the first SCR catalyst. These catalysts can also be observed, for example using microscopy, by the absence of washcoat in the walls of the substrate. In the second zone, the majority of the pores contain the first SCR catalyst. The first SCR catalyst is substantially within the walls of the filter and not on the surface. In the second zone, the second SCR catalyst is substantially on the walls and not in the walls. The term “substantially within the walls and not on the surface” means that the majority of the material is located within the walls and that less than a majority of the material is located on the surface of porous substrate. The term “substantially on the walls and not in the walls” means that majority, preferably at least 75%, 80%, 85%, 90%, or 95%, of the material is present on the walls of the monolith in the second zone. This can be determined, for example by scanning electron microscopy (SEM). When the catalyst comprises a metal, such as copper, (electron probe micro-analysis) EPMA can be used to determine the distribution of the metal in and on the walls.

In at least the first zone, preferably the first SCR catalyst in the walls of the monolith preferably does not cover the walls of the first or second pluralities of channels. The term “does not cover a surface” means that there is no catalytic material present on the walls, there is no catalytic material detected on the walls of the channel, or any catalytic material detected on the walls of the channel is present at a concentration that does not have an impact on the overall catalytic activity of the monolith filter.

In at least the second zone, a second SCR catalyst is present as a coating covering the walls of the second plurality of channels. The catalyst coating comprising the second SCR catalyst can have an average thickness of about 0.1 to 15% of the thickness of the wall upon which the coating is disposed. This thickness does not include any depth associated with penetration into the pores.

The coating is on the outlet side of the porous wall. The coating can cover about 10 to about 90% of the filter length, measured from the second end face. The length of the coating can depend upon the application in which the filter is used. For example, in light duty engines, the coating can cover about 10 to about 50%, about 10 to about 45%, about 10 to about 40%, about 10 to about 35%, about 10 to about 25%, about 10 to about 20%, or about 10 to about 15% of the filter length. Preferably, the coating covers 10 to about 25%, or about 25 to about 50%, more preferably about 10 to about 25%, of the filter length. In heavy duty engines, the coating can cover about 25 to about 90%, about 35 to about 85%, about 10 to about 80%, about 10 to about 75%, about 10 to about 70%, about 10 to about 60%, or about 10 to about 50% of the filter length.

The coating can also comprise a catalyst concentration gradient with the high concentration of the second SCR catalyst being toward the inlet end of the filter.

The ratio of a length of the first zone to a length of the second zone in the longitudinal direction can depend upon the application in which the filter is used. For example, in light duty engines, the ratio can be about 9:1 to about 1:1, about 9:1 to about 3:2, about 9:1 to about 2:1, about 9:1 to about 4:1, about 9:1 to about 5:1, or about 9:1 to about 6:1. Preferably, the ratio is about 9:1 to about 3:1, or about 9:1 to about 4:1, more preferably about 9:1 to about 4:1. In heavy duty engines, the ratio can be about 1:9 to about 3:1, about 2:1 to about 1:6, about 9:1 to about 1:4, about 9:1 to about 1:3, about 9:1 to about 3:7, about 9:1 to about 2:3, or about 9:1 to about 1:1. The size of the particles of the catalyst material can be chosen to limit their movement into the substrate. One skilled in the art would recognize that this size is dependent upon the pores sizes of the monolith filter before treatment.

The coating of the second SCR catalyst can be applied as a catalyst washcoat that contains the second SCR catalyst and optionally one or more other constituents such as binders (e.g., metal oxide particles), fibers (e.g., glass or ceramic non-woven fibers), masking agents, rheology modifiers, and pore formers.

The catalyst material can be deposited as a layer on the walls of the channels. This can be performed by a spraying or dipping approach. The catalytic material can be substantially prevented from infiltrating the porous substrate by one of several techniques, such as using a thick and viscous coating solution as described above.

In the second zone, the catalytic material comprising the second SCR catalyst covers the channel walls of the second plurality of channels from the second end face as a coating on the wall having a thickness of 10 μm to 80 μm, preferably from 15 to 60 μm, more preferably 15 to 50 μm, inclusive.

The catalytic material in the second zone can extend into pores close to the surface of the substrate in the second zone and be present in a portion of the substrate near the coating. This may be necessary for the coating to adhere to the substrate. However, the second SCR catalyst in the second zone is not distributed throughout the porous substrate. The term “not distributed throughout the porous substrate” means that the material is either only present on the walls of the substrate or the material is present with the majority of the material on the walls of the porous substrate and the remainder of the material in located within a portion, but not all of, the porous substrate associated with the second zone.

Preferably the catalytic material coating the channels of the second zone penetrates to one or more of <25%, <20%, <15%, <10%, and <5% of the thickness of the channel wall.

Preferably, in the first zone, the first plurality of channels is free from catalytic material on the surface thereof. The term “free from catalytic material on the surface” means there is no visual appearance of catalytic material, there is no catalytic material detected on the walls of the channel, or any catalytic material detected on the walls of the channel is present at a concentration that does not have an impact on the overall catalytic activity of the monolith filter.

The first SCR catalyst, distributed throughout the first zone of the porous substrate, can be the same as the second SCR catalyst covering the surface of the second plurality of channels. As used in this context, “the same as” means that both the chemical identity of the catalysts and the loading of the catalysts are the same. Two loadings are considered to be the same if they are within 50% of each other.

Alternatively, the first SCR catalyst, distributed throughout the first zone of the porous substrate can be different than the second SCR catalyst covering the surface of the second plurality of channels. As used in this context, “different than” means that the chemical identity of the catalysts and/or the loading of the catalysts are different. For example, a copper chabazite (Cu-CHA) having 3.0% copper by weight is different than a copper chabazite having 3.5% copper by weight. A first SCR catalyst comprising a copper chabazite (Cu-CHA) having 3.0% copper by weight where the first SCR catalyst is present on the filter at a loading of 1.55 g/in³ is different than a second SCR catalyst comprising a copper chabazite (Cu-CHA) having 3.0% copper by weight where the second SCR catalyst is present on the filter at a loading of 1.70 g/in³.

One of the difficulties in treating NOₓ in an exhaust gas is that the quantity of NOₓ present in the exhaust gas is transient, i.e. it varies with driving conditions, such as acceleration, deceleration and cruising at various speeds. In order to overcome this problem, SCR catalysts can adsorb (or store) nitrogenous reductant such as ammonia, thus providing a buffer to the appropriate supply of available reductant. Molecular sieve-based catalysts such as those described above can store ammonia, and the catalyst activity at the onset of exposure of the catalyst to NH₃ can be substantially lower than the activity when the catalyst has a relatively high exposure or saturated exposure to NH₃. For practical vehicle applications, this means the catalyst needs to be pre-loaded with an appropriate NH₃ loading to ensure good activity. However, this requirement presents some significant problems. In particular, for some operating conditions, it is not possible to achieve the required NH₃ loading; and this pre-loading method has limitations because it is not possible to know what the engine operating conditions will be subsequent to pre-loading. For example, if the catalyst is pre-loaded with NH₃ but the subsequent engine load is at idle, NH₃ can be slipped to atmosphere. The rate of increase of activity of the SCR catalyst from zero ammonia exposure to saturated ammonia exposure is referred to as the “transient response”. In this regard, it is preferable that the second SCR catalyst covering the surface of the second plurality of channels is a large-pore zeolite, preferably a copper beta zeolite. Alternatively, other, non-zeolite, catalytic materials can be used such as CeO₂ impregnated with W, CeZrO₂ impregnated with W, or ZrO₂ impregnated with Fe and W. Other suitable catalysts are described in WO2009/001131 and WO2011/064666, which are incorporated herein by reference. Using such large-pore zeolites or non-zeolite materials as a coating is advantageous because these materials generally provide a faster transient SCR response than the small-pore zeolites described above, since they require significantly less pre-loaded ammonia to function effectively. In other words, they have high activity at lower NH₃ exposures (low exposure relative to the saturated storage capacity of the catalyst) compared to the small pore zeolites). There can be a synergistic relationship between the small pore zeolites described above and the large-pore zeolites and non-zeolite materials described presently.

In another aspect, there is provided an emission treatment system for treating a flow of a combustion exhaust gas, the system comprising the catalytic wall-flow monolith as described in the first aspect of the invention. The exhaust systems of the present invention are for use in internal combustion engines and in particular to lean-burn internal combustion engines, especially diesel engines.

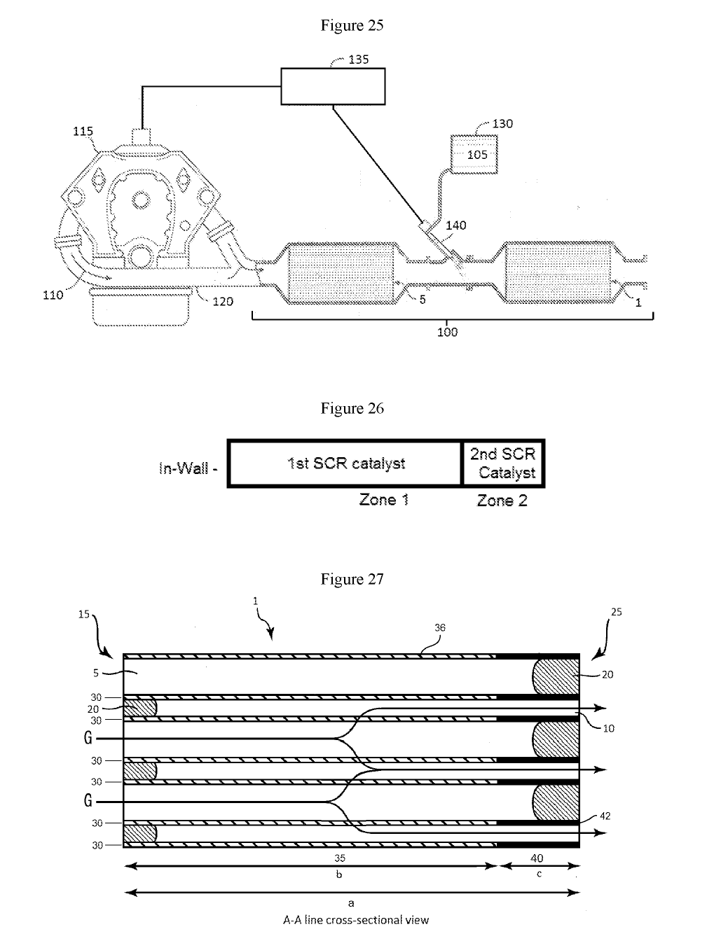

FIGS. 24 and 25 show various features of aspects of systems of the invention. Below is an index with the name of the feature and the corresponding identifier in these figures.

| | |
|---|---|
| Filter of first aspect | 1 |
| Catalyst | 5 |
| exhaust gas treatment system | 100 |
| ammonia reductant | 105 |
| flow of exhaust gas | 110 |
| engine | 115 |
| ducting | 120 |
| reservoir | 130 |
| controller | 135 |
| injection nozzle | 140 |

In an engine with an exemplary exhaust gas treatment system 100, shown in FIG. 24, exhaust gas 110 is passed from the engine 115 through ducting 120 to the exhaust system 100. In the exhaust system 100, an ammonia reductant 105 is injected into the flow of exhaust gas 110 upstream of the wall flow monolith 1. The ammonia reductant 105 is dispensed from a reservoir 130 as required (as determined by controller 135) through an injection nozzle 140 and mixes with the exhaust gas prior to reaching the monolith 1 which contains a first SCR catalyst in the first zone and the entrance of exhaust gas flow into the monolith.

In an engine with an exemplary exhaust gas treatment system 100, shown in FIG. 25, exhaust gas 110 is passed from the engine 115 through ducting 120 to the exhaust system 100. In the exhaust system 100, the exhaust gas first passes through catalyst 5 (such as a diesel oxidation catalyst (DOC), a NOx trap or a passive NOx adsorber (PNA) located in the exhaust system before the ammonia reductant 105 is injected into the flow of exhaust gas 110 upstream of the wall flow monolith 1. The ammonia reductant 105 is dispensed from a reservoir 130 as required (as determined by controller 135) through an injection nozzle 140 and mixes with the exhaust gas prior to reaching the monolith 1 which contains a first SCR catalyst in the first zone and the entrance of exhaust gas flow into the monolith

The catalytic wall flow monolith filters described herein are beneficial for a number of reasons. By placing a second SCR catalyst as a coating over a portion of the first SCR catalyst in the porous wall of the filter, NOx conversion is improved over a conventional SCRF in-wall design. In addition, the concentration of ammonia in the exhaust gas from about 225 to about 300° is less then than from a conventional SCRF in-wall design

The filters described herein allow NOx still present in exhaust gas after exiting the first zone, comprising the first SCR catalyst, via the downstream wall flow filter channels to be able to contact the second SCR catalyst in the on-wall coating. This can provide better contact/accessibility between the reactants and the active catalytic component sites than the configuration where the SCR catalyst is only present in-wall and some of the exhaust gas can by-pass the first zone. This configuration can provide NOx conversion in relatively high flow rate applications; or allow for shorter/less volume substrates that are cheaper to manufacture, potentially lighter (less weight benefit fuel economy and so reduces CO₂ emissions), less problematic to packaging (canning) and easier to find space for on the vehicle. Filters with the configuration described herein can allow for increased gas/catalyst contact because exhaust gas would be able to further contact the second SCR in the coating.

According to a further aspect there is provided a method for the manufacture of a catalytic wall-flow monolith of the first aspect of the invention, the method comprising:

(a) providing a porous substrate having a first end face and a second end face defining a longitudinal direction therebetween and first and second pluralities of channels extending in the longitudinal direction, wherein the first plurality of channels is open at the first end face and closed at the second end face, and wherein the second plurality of channels is open at the second end face and closed at the first end face;

(b) infiltrating the porous substrate with a washcoat comprising the first SCR catalyst to form a first zone and a portion of the second zone, or infiltrating the porous substrate with a washcoat comprising the first SCR catalyst to form a first zone and infiltrating the porous substrate with a washcoat comprising the first SCR catalyst to form a portion of the second zone; or infiltrating the porous substrate with a washcoat comprising the first SCR catalyst to form a portion of the second zone and infiltrating the porous substrate with a washcoat comprising the first SCR catalyst to form a first zone, and

(c) forming a coating of a second SCR catalyst over the first SCR catalyst in the second zone, where the walls of the second plurality of channels are covered by the coating.

Step (b) of a method for the manufacture of a catalytic wall-flow monolith of the first aspect of the invention can comprise infiltrating the porous substrate with a washcoat comprising the first SCR catalyst to form a first zone and a portion of the second zone.

Step (b) of a method for the manufacture of a catalytic wall-flow monolith of the first aspect of the invention can comprise infiltrating the porous substrate with a washcoat comprising the first SCR catalyst to form a first zone and infiltrating the porous substrate with a washcoat comprising the first SCR catalyst to form a portion of the second zone.

Step (b) of a method for the manufacture of a catalytic wall-flow monolith of the first aspect of the invention can comprise infiltrating the porous substrate with a washcoat comprising the first SCR catalyst to form a portion of the second zone and infiltrating the porous substrate with a washcoat comprising the first SCR catalyst to form a first zone.

The coating applied in step (c) can be located from the second end face towards the first end face and can extend in the longitudinal direction for a distance less than the filter length.

The coating applied in step (c) can be located from a distance from the second end face towards the first end face and can extend in the longitudinal direction for a distance less than the filter length.

Two zone configurations are shown in FIGS. 2, 4 and 6.

In the configuration shown in FIG. 2, the entire length of the wall-flow monolith filter of the can be treated with a washcoat comprising a first SCR catalyst, where the first SCR catalyst becomes located within the walls of the filter. The filter containing the first SCR catalyst can be dried and optionally calcined. As shown in FIG. 3, a portion of this treated monolith from the first end face to a distance b towards the second end face forms a first zone. A portion of the monolith filter downstream of the first zone is then coated with a second SCR catalyst that covers the first SCR catalyst and forms a second zone.

Alternatively, a portion of the length of the wall-flow monolith filter from the first end of the filter towards the second end of the filter, corresponding to the length of the first zone, can be treated with a washcoat comprising a first SCR catalyst. The portion of the monolith filter adjacent to the first zone to the second end of the filter can be treated with a washcoat comprising the first SCR catalyst. The filter containing the first SCR catalyst can be dried and optionally calcined. This portion corresponds to the length of the second zone. The filter containing the first SCR catalyst can be dried and optionally calcined, then the portion of the filter from the second end towards the first zone, corresponding to the length of the second zone can be coated with a second SCR catalyst that covers the first SCR catalyst and forms a second zone. The border between the first and second zones can be as described herein.

In the configuration shown in FIG. 4, less than the entire length of the wall-flow monolith filter of the can be treated with a washcoat comprising a first SCR catalyst, where the first SCR catalyst becomes located within the walls of the filter. As shown in FIG. 5, a portion of this treated monolith from the first end face to a distance b towards the second end face forms a first zone. The filter containing the first SCR catalyst can be dried and optionally calcined. A portion of the monolith filter downstream of the first zone can then coated with a second SCR catalyst that covers the first SCR catalyst and forms a second zone. Optionally, a coating that can be removed during calcination, such as a polymer coating, can be applied to the surface of the filter in the second zone before the coating comprising the second SCR catalyst is applied.

In the configuration shown in FIG. 6, less than the entire length of the wall-flow monolith filter of the can be treated with a washcoat comprising a first SCR catalyst, where the first SCR catalyst becomes located within the walls of the filter. As shown in FIG. 7, a portion of this treated monolith from the first end face to a distance b towards the second end face forms a first zone. The filter containing the first SCR catalyst can be dried and optionally calcined. A portion c of the monolith filter downstream of the first zone, the second zone, can then be treated with a washcoat comprising a second SCR catalyst, where the second SCR catalyst becomes located within the walls of the filter. The second zone can then be coated with a second SCR catalyst that covers the second SCR catalyst. Optionally, a coating that can be removed during calcination, such as a polymer coating, can be applied to the surface of the filter in the second zone before the coating comprising the second SCR catalyst is applied. Alternatively, the second SCR catalyst can be applied both in-wall and as an on-wall coating by methods known in the art, such as by increasing the viscosity and having a higher particle size distribution.

Three zone configurations are shown in FIGS. 9, 11 13, 15 and 17.

In the configuration shown in FIG. 9, the entire length of the wall-flow monolith filter of the can be treated with a washcoat comprising a first SCR catalyst, where the first SCR catalyst becomes located within the walls of the filter. The filter containing the first SCR catalyst can be dried and optionally calcined. As shown in FIG. 10, a portion of this treated monolith from the first end face to a distance b towards the second end face forms a first zone. A coating that can be removed during calcination, such as a polymer coating, can be applied to the surface of the filter in the second and third zones (from the second end face to the first zone) before the coating comprising the second SCR catalyst is applied. A portion of the monolith filter downstream of the first zone is then coated with a second SCR catalyst that covers the first SCR catalyst and forms a second zone.

Alternatively, a portion of the length of the wall-flow monolith filter from the first end of the filter towards the second end of the filter, corresponding to the length of the first zone or the first and second zone, can be treated with a washcoat comprising a first SCR catalyst. The remainder of the monolith filter can be treated from the second end face with a washcoat comprising the first SCR catalyst. The filter containing the first SCR catalyst can be dried and optionally calcined. A coating that can be removed during calcination, such as a polymer coating, can be applied to the surface of the filter in the second and third zones (from the second end face to the first zone) before the coating comprising the second SCR catalyst is applied. A portion of the monolith filter downstream of the first zone is then coated with a second SCR catalyst that covers the first SCR catalyst and forms a second zone. The border between the first and second zones can be as described herein.

In the configuration shown in FIG. 11, less than the entire length of the wall-flow monolith filter of the can be treated with a washcoat comprising a first SCR catalyst, where the first SCR catalyst becomes located within the walls of the filter. As shown in FIG. 12, the portion of this treated monolith from the first end face to a distance b+c towards the second end face forms a first zone and part of the second zone. The filter containing the first SCR catalyst can be dried and optionally calcined. The remaining portion of the monolith filter downstream of the first zone, can then be treated with a washcoat comprising a second SCR catalyst, where the second SCR catalyst becomes located within the walls of the filter. A coating that can be removed during calcination, such as a polymer coating, can be applied to the surface of the filter in the third zone and optionally in the second zone before a coating comprising the second SCR catalyst is applied in the second zone.

In the configuration shown in FIG. 13, less than the entire length of the wall-flow monolith filter of the can be treated with a washcoat comprising a first SCR catalyst, where the first SCR catalyst becomes located within the walls of the filter. As shown in FIG. 14, the portion of this treated monolith from the first end face to a distance b towards the second end face forms a first zone. The filter containing the first SCR catalyst can be dried and optionally calcined. A portion of the monolith filter from the second end face 25 towards to front end face 15 can be treated over the distance d with a washcoat comprising a second SCR catalyst, where the second SCR catalyst becomes located within the walls of the filter. A coating that can be removed during calcination, such as a polymer coating, can be applied to the surface of the filter in the third zone and optionally in the second zone before a coating comprising the second SCR catalyst is applied in the second zone.

In the configuration shown in FIG. 15, less than the entire length of the wall-flow monolith filter of the can be treated with a washcoat comprising a first SCR catalyst, where the first SCR catalyst becomes located within the walls of the filter. As shown in FIG. 16, the portion of this treated monolith from the first end face to a distance b+c towards the second end face forms a first zone and part of a second zone. The filter containing the first SCR catalyst can be dried and optionally calcined. A portion of the monolith filter from the second end face 25 towards to front end face 15 can be treated over the distance d with a washcoat comprising a second SCR catalyst, where the second SCR catalyst becomes located within the walls of the filter. A coating that can be removed during calcination, such as a polymer coating, can be applied to the surface of the filter in the third zone and optionally in the second zone before a coating comprising the second SCR catalyst is applied in the second and third zones.

In the configuration shown in FIG. 17, less than the entire length of the wall-flow monolith filter of the can be treated with a washcoat comprising a first SCR catalyst, where the first SCR catalyst becomes located within the walls of the filter. As shown in FIG. 18, the portion of this treated monolith from the first end face to a distance b towards the second end face forms a first zone and part of a second zone. The filter containing the first SCR catalyst can be dried and optionally calcined. A portion of the monolith filter from the second end face 25 towards to front end face 15 can be treated over the distance d with a washcoat comprising a second SCR catalyst, where the second SCR catalyst becomes located within the walls of the filter. A coating that can be removed during calcination, such as a polymer coating, can be applied to the surface of the filter in the third zone and optionally in the second zone before a coating comprising the second SCR catalyst is applied in the second and third zones.

Four zone configurations and shown in FIGS. 20 and 22.

In the configuration shown in FIG. 20, less than the entire length of the wall-flow monolith filter of the can be treated with a washcoat comprising a first SCR catalyst, where the first SCR catalyst becomes located within the walls of the filter. As shown in FIG. 21, the portion of this treated monolith from the first end face to a distance b+c towards the second end face forms a first zone and a portion of the second zone. The filter containing the first SCR catalyst can be dried and optionally calcined. A portion of the monolith filter from the second end face 25 towards to front end face 15 can be treated over the distance d+e with a washcoat comprising a second SCR catalyst, where the second SCR catalyst becomes located within the walls of the filter. A coating that can be removed during calcination, such as a polymer coating, can be applied to the surface of the filter in the third and fourth zone and optionally in the second zone before a coating comprising the second SCR catalyst is applied in the second and third zone.

In the configuration shown in FIG. 22, less than the entire length of the wall-flow monolith filter of the can be treated with a washcoat comprising a first SCR catalyst, where the first SCR catalyst becomes located within the walls of the filter. As shown in FIG. 23, the portion of this treated monolith from the first end face to a distance b towards the second end face forms a first zone. The filter containing the first SCR catalyst can be dried and optionally calcined. A portion of the monolith filter from the second end face 25 towards to front end face 15 can be treated over the distance d+e with a washcoat comprising a second SCR catalyst, where the second SCR catalyst becomes located within the walls of the filter. A coating that can be removed during calcination, such as a polymer coating, can be applied to the surface of the filter in the third and fourth zone and optionally in the second zone before a coating comprising the second SCR catalyst is applied in the second and third zone.

In each of the above methods, unless otherwise noted, drying and calcining can be performed before another washcoat is placed on the filter. In each of the above methods, the treated filter is dried and calcined after all of the washcoats have been placed on the filter.

In each of the above configurations, the wall-flow monolith filter can further comprise a gap between at least a portion of the first zone and the second zone. Preferably there is no gap between at least a portion of the first zone and the second zone.

The above configurations describe the locations of the first and second SCR catalyst. A catalytic wall-flow monolith filter can further comprise one or more additional SCR catalysts where the one or more additional SCR catalysts can be present in one or more of the first second, third and fourth zones. The one or more additional SCR catalysts can be distributed throughout the porous substrate, located in a coating that covers the surfaces of the porous substrate, or both distributed throughout the porous substrate and located in a coating that covers the surfaces of the porous substrate. For example, a third SCR catalyst can be used in place of, or in addition to, the first and/or second SCR catalysts within one or more zones. When the third SCR catalyst is present in place of a first or second SCR catalyst, the above methods can be modified to replace the first and/or second SCR catalysts with the third SCR catalyst within one or more zones. When the third SCR catalyst is present in a zone in addition to a first or second SCR catalyst, the above methods can be modified to add the third SCR catalyst to the first or second SCR catalysts within one or more zones.

The third SCR catalyst can be different than one or more of the first SCR catalyst and the second SCR catalyst.

The third SCR catalyst can be the same as one or more of the first SCR catalyst and the second SCR catalyst.

Two adjacent zones can preferably meet at a border that is in a plane approximately parallel to the first and second end faces. This facilitates the wash-coating process. However, it is also possible to have a border which varies across the cross-section of the monolith, such as a cone-shaped border. This can advantageously be used to increase the volume of one or more of a second, third or fourth zone within the monolith, since a central area of the monolith can experience elevated temperatures.

Selective infiltration of the substrate by the washcoat can be performed by immersing the substrate vertically in a catalyst slurry such that the desired boundary between the first and second substrate zones is at the surface of the slurry. The substrate can be left in the slurry for a sufficient period of time to allow the desired amount of the slurry to move into the substrate. The period of time should be less than 1 one minute, preferably about 30 seconds. The substrate is removed from the slurry, and excess slurry is removed from the wall-flow substrate first by allowing it to drain from the channels of the substrate, then by blowing on the slurry on the substrate with compressed air (against the direction of slurry penetration), and then pulling a vacuum from the direction of slurry penetration. By using this technique, the catalyst slurry permeates the walls of the first zone of the substrate, yet the pores are not occluded to the extent that back pressure will build up in the finished substrate to unacceptable levels. One skilled in the art would recognize the unacceptable levels for the back pressure depend upon a variety of factors including the size of the engine to which the filter is connected, the conditions under which the engine is run and the frequency and method of regenerating the filter.

The coated substrates are dried typically at about 100° C. and calcined at a higher temperature (e.g. 300 to 500° C.). After calcining, the washcoat loading can be determined from the coated and uncoated weights of the substrate. The catalyst loading can be determined from the washcoat loading based on the amount of catalyst in the washcoat. As will be apparent to those of skill in the art, the washcoat loading can be modified by altering the solids content of the coating slurry. Alternatively, repeated immersions of the substrate in the coating slurry can be conducted, followed by removal of the excess slurry as described above.

The coating of the second catalytic material can be formed as described above and in U.S. Pat. No. 6,599,570, U.S. Pat. No. 8,703,236 and U.S. Pat. No. 9,138,735. To prevent coating of the second catalytic material from forming in the first zone of the substrate, the surface in the first zone can be pre-coated with a protective polymeric film, such as polyvinyl acetate. This prevents the catalytic material from adhering to the surface of the substrate in the first zone. The protective polymeric coating can then be burnt off.

Preferably the catalytic wall-flow monolith manufactured according to the foregoing method is the monolith as described herein. That is, all features of the first aspect of the invention can be freely combined with the further aspects described herein.

According to a further aspect of the invention, provided is a method for treating a flow of a combustion exhaust gas comprising NOₓ and particulate matter, the method comprising passing the exhaust stream through the monolith of the first aspect of the invention.

According to a further aspect of the invention, provided is a method for modifying the soot burn of soot collected within a wall-flow monolith, the method comprising passing an exhaust stream comprising soot through the monolith of the first aspect of the invention. Passing an exhaust stream comprising soot through the monolith of the first aspect of the invention can change the distribution of soot in the filter. This change in distribution can modify the soot burn of soot collected within a wall-flow monolith.

### EXAMPLES

### Example 1.—In-Wall Coating (Comparative)

FIG. 26 is a schematic diagram showing the location of the two SCR catalysts in Example 1, a comparative example where both of the SCR catalysts are within the filter. There are two zones with the second zone 40 downstream of the first zone 35. The first zone comprises the first SCR catalyst and the second zone comprises the second SCR catalyst. Neither of the zones have an SCR catalyst on the walls of the substrate.

FIG. 27 is a cross-sectional view of the wall flow monolith filter showing the location of the two SCR catalysts in Example 3. The monolith filter comprises a first zone 35 that contains the first SCR catalyst 36 within the walls 30 of the monolith filter and extends from the first end face 15 a distance b towards the second end face 25. When the exhaust gas G passes through the porous channel walls 30, material in the exhaust gas can react with the first SCR catalyst 36 within the walls 30. The monolith filter also comprises a second zone 40 that comprises the second SCR catalyst 42 in the walls 30 of the monolith filter. The second zone 40 is downstream of the first zone 35 and extends from the first zone a distance c towards the second end face 25.

Filters having the configuration shown in FIG. 26 were prepared by coating a washcoat comprising a binder, 4.15% Cu-CHA and CHA into a filter substrate (6.5 in. diameter×5.5 in. length) for a distance of 85% of the length from the front end. The 4.15% Cu-CHA and CHA were present at a loading of 1.28 and 0.428 g/in³, respectively. The filter substrate was then dried and the mixture was coated into the filter substrate for a distance of 15% of the length from the rear end. The filters were dried, then the filters were calcined at 500° C. for 1 hour. Some of the filters were hydrothermally aged at 900° C. for 1 hour with 10% H₂O.

### Example 2.—On-Wall Coating on Rear Portion of Filter

Filters having the configuration shown in FIGS. 4 and 5 were prepared by coating 85% of the length of the filter from the front end with a washcoat comprising a binder, 4.15% Cu-CHA and CHA into a filter substrate (6.5 in. diameter×5.5 in. length) for a distance of 85% of the length from the front end, then placing an on-wall coating of a washcoat comprising a binder, 4.15% Cu-CHA and CHA over 15% of the length of the filter from the rear-end. The filters were dried, then calcined at 500° C. for 1 hour. Some of the filters were hydrothermally aged at 900° C. for 1 hour with 10% H₂O. Some of the filters were hydrothermally aged at 800° C. for 16 hours with 10% H₂O.

### Example 3.—On-Wall Coating Towards Front of Filter (Comparative)

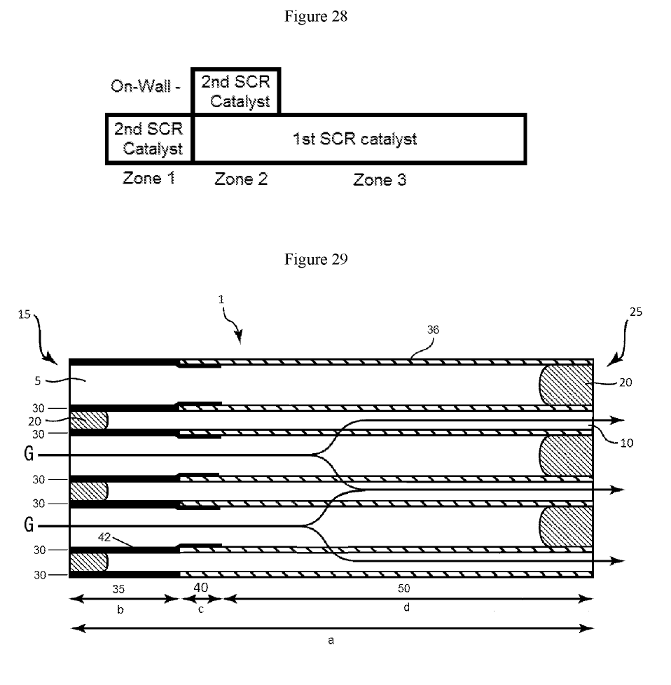

FIG. 28 is a schematic diagram showing the location of the two SCR catalysts in Example 3, a comparative example where the second SCR catalyst is present within the walls of a portion of the filter and as a coating on the wall on a different portion of the filter, and the first SCR catalyst is present in the walls of the filter. There are three zones with the second zone downstream of the first zone and the third zone downstream of the second zone. The first zone comprises the second SCR catalyst within the wall of the substrate. Both the second and third zones comprise the first SCR catalyst within the walls of the substrate. The second zone also comprises a coating of a second SCR catalyst on the walls.

FIG. 29 is a cross-sectional view of the wall flow monolith filter showing the location of the two SCR catalysts in Example 3. The monolith filter comprises a first zone 35 that contains the second SCR catalyst 42 within the walls 30 of the monolith filter. The first zone extends from the first end face 15 a distance b towards the second end face 25. The second zone comprises the first SCR catalyst 36 in the walls 30 of the monolith filter and the second SCR catalyst 42 on the walls 30 of the monolith filter. The second zone 40 is downstream of the first zone 35 and extends from the first zone a distance c towards the second end face 25. When the exhaust gas G passes into the second SCR catalyst 42 on the walls of the filter, it can react with the second SCR catalyst. When the exhaust gas G passes through the porous channel walls 30, material in the exhaust gas can react with the first SCR catalyst 36 within the walls 30.

Filters having the configurations shown in FIGS. 28 and 29 were prepared by coating a washcoat comprising a binder, 4.15% Cu-CHA and CHA into a filter substrate (6.5 in. diameter×5.5 in. length) for a distance of 75% of the length from the rear end. The 4.15% Cu-CHA and CHA were present at a loading of 1.28 and 0.428 g/in³, respectively.

The filter substrate was then dried and the mixture was coated into the filter substrate for a distance of 30% of the length from the rear end. The filters were dried, then the filters were calcined at 500° C. for 1 hour. Some of the filters were hydrothermally aged at 900° C. for 1 hour with 10% H₂O.

### Example 4—Comparative Testing of Example 1 and 2

Testing Methods and Conditions

Samples of Example 1 and 2 were tested on a car with a 3I V6 engine. A diesel oxidation catalyst (DOC) was located before the samples of Examples 1 or 2. The vehicle was operated at an ammonia:NOx ratio (alpha) of 1.2. The load on the engine was adjusted to bring the inlet temperature of the filter to 610° C., then the inlet temperature was maintained at 610° C. for about 20 minutes. The load was then reduced and the temperature at the inlet decreased to 420° C. The inlet temperature was maintained at 420° C. for about 20 minutes. The load on the engine was reduced several times so that the inlet temperatures were maintained at the temperatures shown in the table below. While the temperatures were maintained at a steady state, measurements were made of the gas flow and various components in the exhaust, as shown below.

Engine Out Values

| SCR Inlet | | | | | |
|---|---|---|---|---|---|
| Temp | NOₓ | NO₂:NO | HC | CO | Airflow |
| (° C.) | (ppm) | ratio | (ppm) | (ppm) | (kg/hr) |
| 610 | 455 | 4 | 1350 | 600 | 389 |
| 420 | 535 | 4 | 45 | 14 | 403 |
| 350 | 595 | 4 | 45 | 14 | 380 |
| 300 | 420 | 2 | 82 | 28 | 320 |
| 275 | 365 | 2 | 112 | 43 | 301 |
| 250 | 325 | 1 | 126 | 59 | 291 |
| 220 | 380 | 1 | 124 | 24 | 153 |

When the engine temperature was at about 600° C., filter regeneration occurred and hydrocarbon was introduced into the exhaust gas stream to remove soot from the filter. This is seen in the above table by the large amounts of hydrocarbons (HC) and carbon monoxide (CO) in the exhaust gas from the engine at 610° C.

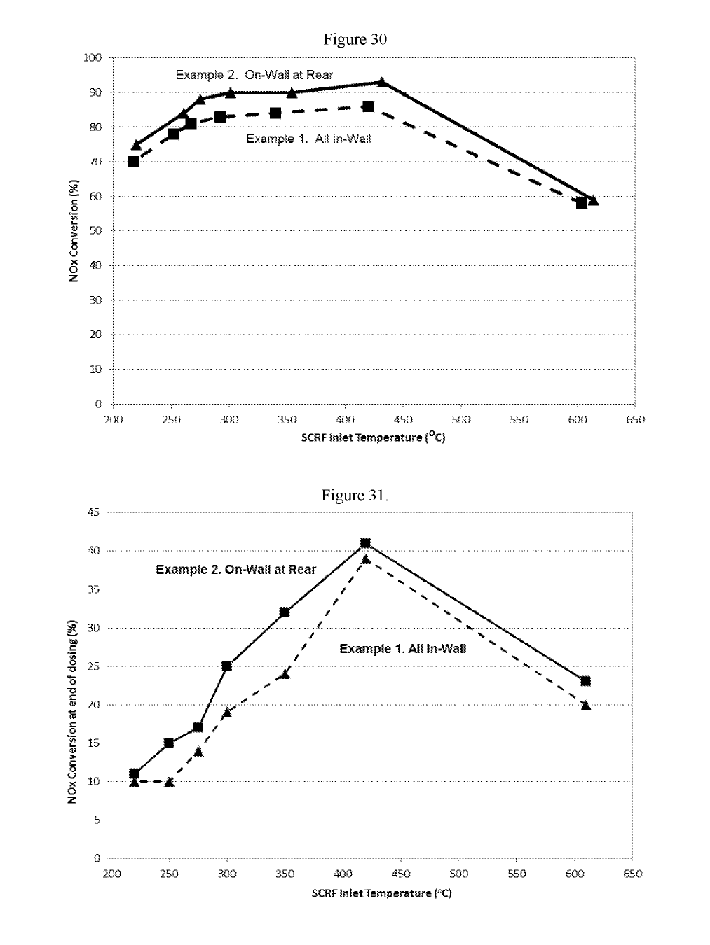

FIG. 30 shows the % NOx conversion from fresh filters with all of the SCR catalyst in-wall (Example 1) and with a rear on-wall coating (Example 2). The filter with the rear on-wall catalyst proved better NOx conversion at all temperatures from about 220 to about 620° C.

FIG. 31 shows the % NOx conversion from hydrothermally aged (900° C./16 hr) filters with all of the SCR catalyst in-wall (Example 1) and with a rear on-wall coating (Example 2). The filter with the rear on-wall catalyst proved better NOx conversion at all temperatures from about 250 to about 620° C.

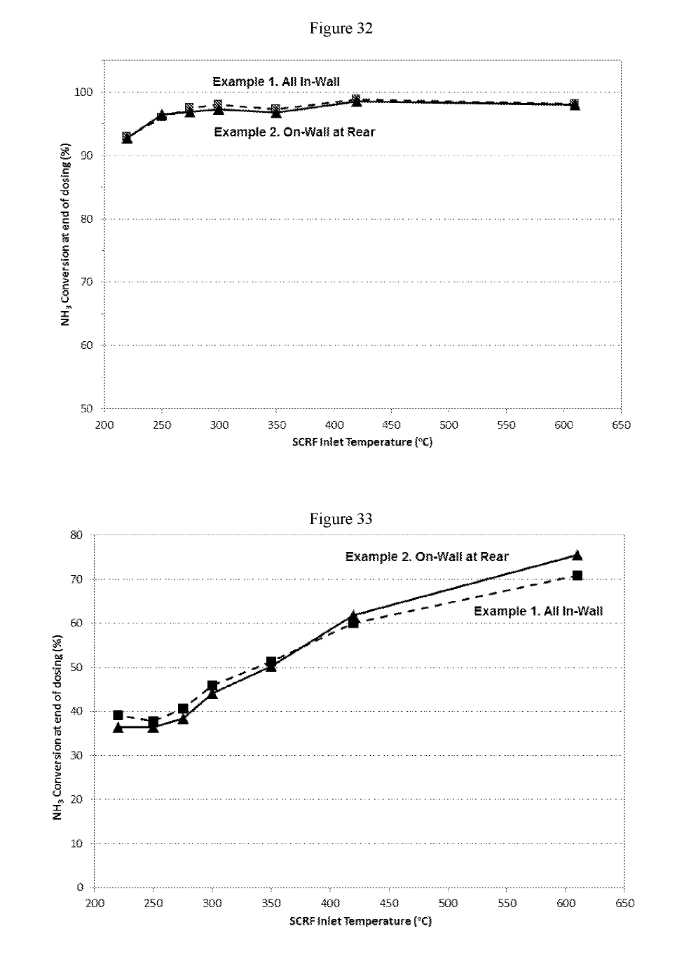

FIG. 32 shows the % NH₃ conversion from fresh filters with all of the SCR catalyst in-wall (Example 1) and with a rear on-wall coating (Example 2). Both filters proved similar NH₃ conversion at all temperatures from about 220 to about 620° C.

FIG. 33 shows the % NH₃ conversion from hydrothermally aged (900° C./16 hr) filters with all of the SCR catalyst in-wall (Example 1) and with a rear on-wall coating (Example 2).

Both filters proved similar NH₃ conversion.

### Example 5—Comparative Testing of Example 2 and 3

Testing Methods and Conditions

Samples of Example 1 and 2 were tested on a car with a 31 V6 engine as described above. While the temperatures were maintained at a steady state, measurements were made of the gas flow and various components in the exhaust, as shown below.

Engine Out Values

| Temperature | Airflow | Inlet NOx | Inlet NO₂ ratio |
|---|---|---|---|
| (° C.) | (kg/hr) | (ppm) | (%) |
| 610 | 388 | 445 | 1 |
| 450 | 385 | 485 | 2 |
| 350 | 361 | 550 | 1 |
| 300 | 318 | 400 | 1 |
| 275 | 306 | 360 | 1 |
| 250 | 290 | 310 | 1 |
| 220 | 156 | 360 | 1 |

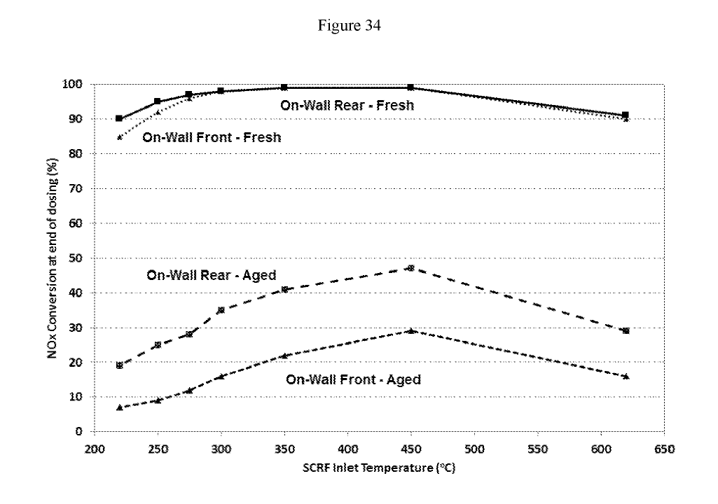

FIG. 34 shows the percent NOx conversion using fresh and hydrothermally aged filters of Examples 2 and 3. The fresh filter with the rear on-wall coating (Example 2) provided better NOx conversion than the fresh filter with the front on-wall coating (Example 3) at temperatures of about 220 to 250° C. FIG. 34 also shows that, as expected, both filters aged hydrothermally at 900° C. for 1 hour provided reduced NOx conversion compared to fresh filters. However, the amount of NOx conversion from the aged filter with the rear on-wall coating (Example 2) was much higher (approximately twice) than NOx conversion in the filter with the front on-wall coating (Example 3). Filters having a rear on-wall coating can have improved NOx performance at low temperatures. These filters can be more thermally durable and maintain higher NOx performance throughout the temperature range.

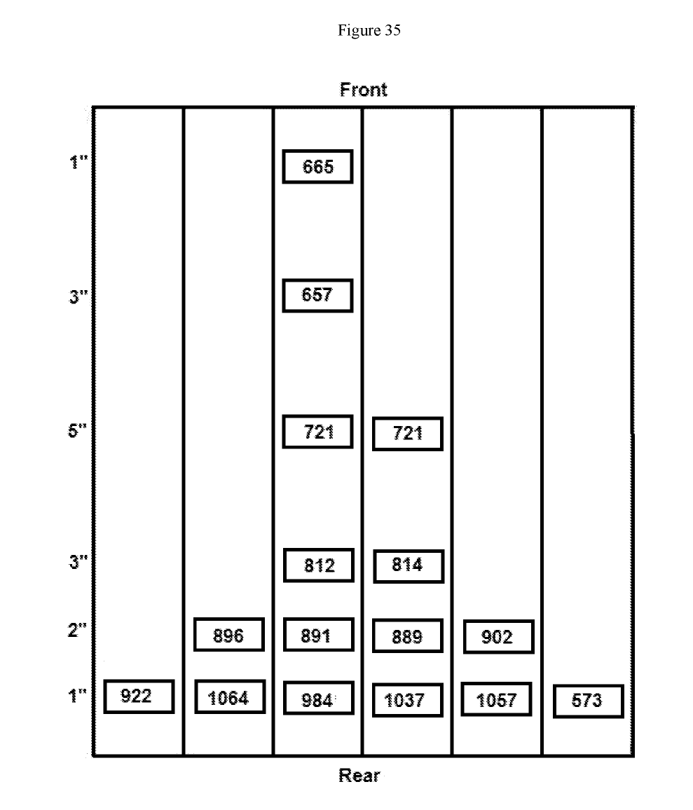

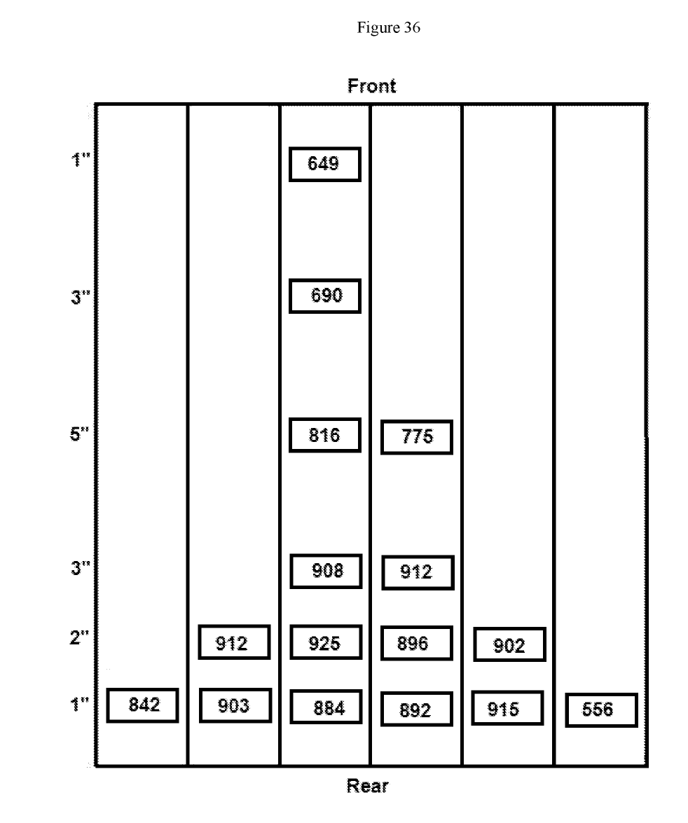

FIGS. 35 and 36 show the temperatures in various locations in the filter of Example 3 (Overlap at Front) and Example 2 (Overlap at Rear), respectively. The table below shows the average maximum temperature at different distance from the front or rear of the filter, but do not including measurements nearest outside of filter due to the large differences between the outside measurements.

| | |
|---|---|
| | Average Maximum Temperature |
| | (not including measurements |
| Filter | nearest outside of filter) |

| Front | On-wall Front | On-wall Rear |
|---|---|---|
| 1″ | 665 | 649 |
| 3″ | 657 | 690 |
| 5″ | 721 | 795 |
| 3″ | 813 | 910 |
| 2″ | 894 | 906 |
| 1″ | 1035 | 898 |
| Rear | | |

The above table shows that a filter having a coating on the wall at the front of the filter reaches maximum temperatures from about 3″ from the front of the filter to about 3″ from the rear of the filter that much less

The rear end of the filter having the coating towards the front (Example 3) has temperatures reached about 1000° C., which is about 100° C. higher than those found in the rear end of the filter having the coating towards the rear (Example 2).

The filter having the coating towards the rear (Example 2) has higher maximum temperatures from about the middle of the length of the filter until before 2″ from the rear end of the filter. The heat is distributed over a larger area in the filter of Example 2 than in the filter of Example 3. This results in maximum temperatures of about 800° to about 900° C. in the area from the middle of the length of the filter until before 2″ from the rear end of the filter in Example 2. The temperatures in this area can provide better soot oxidation than in the same areas of the filter of Example 3, without having temperatures reaching about 1000° C. as is found in the last inch of the filter in Example 3.

It will be understood by those skilled in the art that variations to the composition and configurations of the catalytic wall-flow monolith filter and systems comprising the catalytic wall-flow monolith filter can be made thereto without departing from the scope of the invention or of the appended claims.

1. A catalytic wall-flow monolith filter for use in an emission treatment system comprising a ceramic wall-flow filter having a first end face, a second end face, a filter length defined by a distance from the first end face to the second end face, a longitudinal direction between the first end face and the second end face, and first and second pluralities of channels extending in the longitudinal direction, wherein the first plurality of channels is open at the first end face and closed at the second end face, and the second plurality of channels is open at the second end face and closed at the first end face, wherein the ceramic wall-flow filter comprises a porous substrate having surfaces that define the channels and having a first zone extending in the longitudinal direction from the first end face towards the second end face for a distance less than the filter length and a second zone downstream of the first zone, wherein the first zone comprises a first SCR catalyst distributed throughout the porous substrate, and the second zone comprises a second SCR catalyst located on a layer that covers the surfaces of the porous substrate.

2. The catalytic wall-flow monolith filter according to claim 1, wherein the second zone further comprises one or more of the first SCR and the second SCR distributed throughout the porous substrate.

3. The catalytic wall-flow monolith filter according to claim 1, wherein the second zone extends to the second end face.

4. The catalytic wall-flow monolith filter according to claim 1, further comprising a third zone downstream of the second zone, where the third zone comprises at least one SCR catalyst distributed throughout the porous substrate.

5. The catalytic wall-flow monolith filter according to claim 4, wherein the second zone further comprises a second SCR catalyst located on a layer that covers the surfaces of the porous substrate.

6. The catalytic wall-flow monolith filter according to claim 4, wherein the second zone extends to the second end face.

7. The catalytic wall-flow monolith filter according to claim 3, further comprising a fourth zone downstream of the third zone, where the fourth zone comprises at least one SCR catalyst distributed throughout the porous substrate.

8. The catalytic wall-flow monolith filter according to claim 7, wherein the fourth zone comprises the second SCR distributed throughout the porous substrate.

9. The catalytic wall-flow monolith filter according to claim 1, wherein the distance from the second end face to the first zone is between about 5% to about 25% of the length of the substrate.

10. The catalytic wall-flow monolith filter according to claim 1, wherein in the first zone, the first SCR catalyst does not cover a surface of the first or second pluralities of channels.

11. The catalytic wall-flow monolith filter according to claim 1, wherein the first SCR catalyst is the same as the second SCR catalyst.

12. The catalytic wall-flow monolith filter according to claim 1, wherein the first SCR catalyst is different than the second SCR catalyst.

13. The catalytic wall-flow monolith filter according to claim 1, wherein at least one of the first SCR catalyst and the second SCR catalyst comprise a molecular sieve or a base metal.

14. The catalytic wall-flow monolith filter according to claim 1, wherein at least one of the first SCR catalyst and the second SCR catalyst comprise a small-pore molecular sieve.

15. The catalytic wall-flow monolith of claim 14, wherein the small pore molecular sieve has a framework structure independently selected from the group consisting of AEI, AFT, CHA, DDR, EAB, ERI, GIS, GOO, KFI, LEV, LTA, MER, PAU, VNI and YUG.

16. The catalytic wall-flow monolith filter according to claim 1, wherein at least one of the first SCR catalyst and the second SCR catalyst comprises a medium or large pore molecular sieve.

17. The catalytic wall-flow monolith filter according to claim 1, wherein at least one of the first SCR catalyst and the second SCR catalyst comprises CeO₂ impregnated with W, CeZrO₂ impregnated with W, and ZrO₂ impregnated with Fe and W.

18. A catalytic wall-flow monolith filter according to claim 1, wherein the first SCR catalyst comprises a small-pore molecular sieve, preferably having a framework structure selected from the group consisting of AEI, AFT, CHA, DDR, EAB, ERI, GIS, GOO, KFI, LEV, LTA, MER, PAU, VNI and YUG structural families.

19. A catalytic wall-flow monolith filter according to claim 1, wherein the second SCR catalyst is a large-pore molecular sieve or a non-zeolite material selected from CeO₂ impregnated with W, CeZrO₂ impregnated with W, or ZrO₂ impregnated with Fe and W.

20. An emission treatment system for treating a flow of a combustion exhaust gas, the system comprising the catalytic wall-flow monolith filter according to claim 1, wherein the first end face is upstream of the second end face.

21. A method for the manufacture of a catalytic wall-flow monolith filter of claim 1, the method comprising:
(a) providing a porous substrate having a first end face and a second end face defining a longitudinal direction therebetween and first and second pluralities of channels extending in the longitudinal direction, wherein the first plurality of channels is open at the first end face and closed at the second end face, and wherein the second plurality of channels is open at the second end face and closed at the first end face;
(b) infiltrating the porous substrate with a washcoat comprising the first SCR catalyst to form a first zone and a portion of the second zone, or infiltrating the porous substrate with a washcoat comprising the first SCR catalyst to form a first zone and infiltrating the porous substrate with a washcoat comprising the first SCR catalyst to form a portion of the second zone; or infiltrating the porous substrate with a washcoat comprising the first SCR catalyst to form a portion of the second zone and infiltrating the porous substrate with a washcoat comprising the first SCR catalyst to form a first zone, and
(c) forming a coating of a second SCR catalyst over the first SCR catalyst in the second zone, where the walls of the second plurality of channels are covered by the coating.

22. A method for treating a flow of a combustion exhaust gas comprising NOₓ, the method comprising passing the exhaust stream through the monolith of claim 1, wherein the first end face is upstream of the second end face.
